(19) United States
(12) Patent Application Publication
(10) Pub. No.: US 2014/0056461 A1
(43) Pub. Date: Feb. 27, 2014

(54) SYSTEMS AND METHODS FOR A VIBRATING INPUT DEVICE

(71) Applicant: Immerz, Inc., Cambridge, MA (US)

(72) Inventor: Shahriar S. Afshar, Encino, CA (US)

(73) Assignee: IMMERZ, INC., Cambridge, MA (US)

(21) Appl. No.: 13/972,546

(22) Filed: Aug. 21, 2013

Related U.S. Application Data
(60) Provisional application No. 61/691,583, filed on Aug. 21, 2012.

(51) Int. Cl. H04R 1/00

(52) U.S. Cl. CPC H04R 1/00
USPC 381/385

(57) ABSTRACT

The application includes an apparatus comprising of a housing, processing circuitry for receiving and transmitting user input, and a transducer for transforming audio information in an electrical signal into both acoustic and haptic signals. The transducer is disposed within the housing, and has a speaker including a diaphragm and a mass element attached to a portion of the diaphragm. Systems and methods also provide an input interface connected to the processing circuitry for receiving user input, and wherein the haptic signal is generated, activated, controlled, modulated, reconfigured, or adjusted, directly or indirectly, in response to a user input received at the user input interface. In this way, haptic effects may be directly generated from audio information and based on input actions taken by the user.

### CROSS-REFERENCE TO RELATED APPLICATIONS

This application claims the benefit of U.S. Provisional Application No. 61/691,583, filed Aug. 21, 2012, the contents of which are incorporated by reference herein in its entirety.

### BACKGROUND

Today there are many types of input devices that allow users to interact with computing devices. When playing computer games, a mouse, a keyboard, or a joystick is often used to control the game's characters and interact with the games' virtual environment. Current methods for supplementing a user's experience have drawbacks which compromise the user's comfort and perception of the content being presented. For example, electrical signals dedicated to conveying haptic information may need to be generated and transmitted in addition to electrical signals that convey audio information. The added redundancy in signal transmission limits overall system performance, especially when haptic devices are wirelessly connected to a central processor responsible for generating haptic and audio information. In addition, when playing games with haptic devices, it is often confusing to know which haptic effects belong to the user or are associated with actions taken by the user, instead of from other users or other virtual environmental factors.

Thus, a need exists for systems and methods that improve the user's interaction with the content being presented. It is desirable that the system does not distract from the content being presented. It is also desirable that the system is portable, efficient, easy to use, inexpensive, and suitable for long term use. In addition, there is a need to categorize and configure vibrational feedbacks according to whether haptic effects are associated with different users.

### SUMMARY

The application includes an apparatus connectable with an electronic and/or consumer electronic device to provide haptic information and/or feedback to a user of the electronic device. The apparatus includes a housing, processing circuitry for receiving and transmitting user input, and one or more transducers for transforming audio information in an electrical signal into both acoustic and haptic signals. The apparatus may include an electrical and/or mechanical connection with an electronic device to enable the exchange of electronic data between the apparatus and the electronic device.

The apparatus housing may include a hard case having a relatively low mass to enhance the propagation of haptic information (e.g., vibrations). The apparatus may also include a user interface for receiving user input information. A user may interface with the apparatus via one or both hands. The apparatus may be segregated into a plurality of physical regions where some regions are associated with vibration units providing certain haptic information. Some regions may be associated with the user interface for collecting user input information. The one or more transducers may be disposed within the housing to provide at least one of acoustic and haptic output to a user of the electronic device, based on audio information in an electrical signal received at the one or more transducers. At least one of the transducers may include a diaphragm and a mass element attached to a portion of the diaphragm. Audio information for acoustic and haptic output signal generation may be associated with media being displayed, played, and/or stored on the electronic device. The electrical signals containing such audio information may be generated in response to user input received through the user input interface, and the audio information may be generated according to the user input.

In one aspect, electronic devices connected to the haptic apparatus described herein may include a computer, game console, cellular telephone, portable computer, personal digital assistant, consumer electronic device and/or any appropriate hand-held electronic device. The haptic apparatus describe herein may be implemented in the form of a skin, shell, case, and/or cover for a mobile media device, or an acoustic-haptic transducer attached to a portion of the user's body, with integrated processing circuitry and/or a user interface. The processing circuitry and/or the user interface may also be encased separately but connected to the transducer wirelessly or though a wired connection.

In some aspects, systems and methods described herein includes an user interface that comprises at least one of a button, a scroll wheel, a scroll button, a switch, a touch-sensitive region on a housing, a touch screen, a light pen, a joystick, or a motion sensor. Some examples of user interfaces are a mouse, keyboard, device casing with function switches, and docking station with user input keypads. A vibrating membrane may be overlaid onto the user input interface and arranged to provide haptic sensations to a user while interfacing with the user interface. The vibrating membrane may be substantially transparent and may include at least one waveguide. In certain embodiments, the user input interface may be virtual, such as a virtual keyboard displayed on a touchscreen. Systems and methods described herein may further include a datastore. The datastore may be arranged to store one or more audio files. The processing circuitry may be arranged to receive input from the user interface and, in response, retrieving a file from the datastore to send to a transducer or a vibration source coupled to the vibrating membrane. In certain embodiments, the vibrating source converts the electronic data of the file to an acoustic and/or haptic signal emitted from the vibrating membrane.

In some aspects, the processing circuitry described herein can receive, process and transmit user input information. In some embodiments, haptic signals are selectively generated according to the user input information. For example, haptic information may be generated to simulate gun recoils when a user plays a shooting game through the user input interface on the haptic device, while no haptic information is produced for shootings by other players within the game. Such selective generation of haptic signals may be carried out by the processing circuitry within the haptic device, or by other processing circuitry within the electronic device. Alternatively, user input information may be transmitted by the haptic device to processing circuitries within the electronic device, which in term transmit user-input dependent audio information to the haptic device. In other words, electrical signals containing audio information may be generated in response to user input, wherein the audio information in the electrical signal is generated according to the user input. The processing circuitry may also be configured to process the electrical signals in response to user input, wherein the processing may include modulating, reconfiguring, or adjusting the electrical signals based on user input.

For example, the processing circuitry can feature at least one of a pitch controller, a volume controller, a fade-in device, an amplitude-ceiling device, and a bass-enhancement device. The pitch controller can modulate a pitch characteristic of an electrical signal. The volume controller can adjust, or raise and lower an amplitude characteristic of an electrical signal. The fade-in device can gradually raise an amplitude characteristic of an electrical signal. The amplitude-ceiling device can reconfigure the electrical signal by imposing an upper limit on an amplitude characteristic of an electrical signal. The bass-enhancement device can reconfigure the electrical signal by sampling a first electrical signal to create a sampled signal, modulating a pitch characteristic of the sampled signal to create a modulated sampled signal, and mixing the modulated sampled signal with the first electrical signal. The processing circuitry can also feature a signal processing component capable of detecting that no electrical signal has been received for a preset amount of time, a power supply, and an automatic shut-off device that can turn off parts of the processing circuitry in response to detecting that no electrical signal is being received for the preset amount of time. The processing circuitry can also feature a low frequency cross-over circuit capable of filtering through low frequency sound from an electrical signal and an amplifier capable of amplifying the electrical signal. By processing of the electrical signals, the processing circuitry directly or indirectly generates, actives, controls, modulates, reconfigures, or adjusts haptic output signals in response to a user input receive at the user interface.

In one aspect of the disclosure, the one or more transducers form a vibrator or a vibration device, capable of converting an electrical signal into vibration based on the audio information in the electrical signal. In some implementations of the disclosure, the vibrator or vibration device includes at least one of an acousto-haptic transducer, an inertial transducer, an off-balance rotor, a tactile transducer, or a piezoelectric transducer. A surface of the vibrator or vibration device can be made of at least one of synthetic rubber, foam cushion, polyurethane, speaker cover fabric, or silicone. In some implementation of the disclosure, the vibrator generates haptic signals based on the audio information in the electrical signal in response to the user input received through the user input interface.

In another aspect of the disclosure, systems and methods described herein include a vibrator capable of converting an electrical signal into a vibration and a support structure for arranging the vibrator. The support structure can arrange the vibrator at a location on or about a human body such that a first pattern of vibrations are generated on the body's surface, where the first pattern matches in relative amplitude a second pattern of surface vibrations generated when the body generates sound. The support structure can dispose a plurality of vibrators on a front-back coronal plane of the body and symmetrically across a left-right median plane of the body. The vibrator can be arranged on or about a side of a torso of the body. In one implementation of the disclosure, the support structure includes a stretchable band adapted to encircle a torso of the body.

### BRIEF DESCRIPTION OF THE DRAWINGS

The foregoing and other objects and advantages of the disclosure will be appreciated more fully from the following further description thereof, with reference to the accompanying drawings wherein:

FIG. 1 depicts a front view of vibrator locations with respect to the body's underlying musculature;

FIG. 2 depicts a front view of vibrator locations with respect to the body's underlying skeletal system;

FIG. 3 depicts a front view of vibrator locations with respect to the body's external surface;

FIGS. 4A and 4B depict, respectively, an oblique view and a side view of vibrator locations with respect to the body's anatomical planes;

FIG. 5 depicts a front view of an exemplary vibration system for experiencing audio and haptic data;

FIGS. 6A, 6B, and 6C depict, respectively, a front view, an oblique view, and a side view of an exemplary vibration device for applying vibrations to the user and capable of being used in the vibration system of FIG. 5;

FIG. 7 depicts a side view of an exemplary harness and an exemplary adjustable endpiece both capable of being used in the vibration devices of FIGS. 5-6C;

FIG. 8 depicts an oblique view of an exemplary vibrator capable of being used in the vibration devices of FIGS. 5-6C, 9-12, and 16;

FIG. 9 depicts a front view of an exemplary vibration system for experiencing audio and haptic data;

FIG. 10A, 10B, and 10C depict, respectively, a front view, a side view, and a top view of an exemplary vibration device for applying vibrations to the user and capable of being used in the vibration system of FIG. 9;

FIG. 11 depicts a front view of an exemplary vibration device and exemplary audio speakers being applied to the user and capable of being used in the vibration system of FIG. 9;

FIGS. 12 depicts, a front view and of an exemplary vibration device for applying vibrations to the user;

FIG. 13 depicts a front view of vibrator locations with respect to the body's underlying musculature;

FIG. 14 depicts a front view of vibrator locations with respect to the body's underlying skeletal system;

FIG. 15 depicts a front view of vibrator locations with respect to the body's external surface;

FIG. 16 depicts a front view of an exemplary vibration device for applying vibrations to the user;

FIG. 17 depicts a natural surface vibration pattern that can be used to determine vibrator locations;

FIG. 18 depicts a vibrator-induced surface vibration pattern that can be used to evaluate vibrator locations;

FIG. 19 depicts an exemplary block diagram of processing circuitry that can be used in a vibration system;

FIGS. 20A and 20B depict side and perspective views of an acousto-haptic transducer, according to an illustrative embodiment of the invention;

FIG. 21 depict a side view of an acousto-haptic transducer, according to an illustrative embodiment of the invention;

FIG. 22 is a block diagram of an acousto-haptic transducer coupled processing circuitry, according to an illustrative embodiment of the invention;

FIG. 23 is a block diagram of two acousto-haptic transducers coupled to processing circuitry, according to an illustrative embodiment of the invention;

FIG. 24 depicts an exemplary mouse with vibrators, according to an illustrative embodiment of the invention;

FIGS. 25A-27B depict exemplary docking units for a portable electronic device and exemplary techniques for attaching a vibration device to the exemplary docking units;

FIGS. 28A-28C depict exemplary vibration devices having mass elements for experiencing audio and haptic data;

FIGS. 29A-29D depict various closed and open views of an exemplary acousto-haptic apparatus for use with a portable electronic device; and

FIGS. 30A-31D depict exemplary waveguides for use with a portable electronic device;

### DESCRIPTION OF ILLUSTRATED EMBODIMENTS

The systems and methods described herein relate to a haptic device capable of producing acoustic as well as haptic signals from audio information contained in an electrical signal. The systems and methods described herein also include any suitable peripheral such as an input device that serve as an interface and provide data and control signals to a computer or other suitable processing circuitry. Processing circuitry disposed within a housing of the haptic device described herein is capable of receiving, processing, and/or transmitting user input information, while one or more transducers disposed within the housing are capable of transforming audio information in an electrical signal into both acoustic and haptic signals. The transducer incudes a speaker with a diaphragm and a mass element attached to a portion of the diaphragm. The haptic device may further include a user input interface dispose on the housing and connected to the processing circuitry for directly receiving user input information that can be used to activate and control, directly or indirectly, haptic signals thus generated by the transducer. Systems implementing the haptic device described herein may allow only haptic signals that correspond to user input information received through the user input interface. The systems and methods described herein will now be described with reference to certain illustrative embodiments. However, the invention is not to be limited to these illustrated embodiments which are provided merely for the purpose of describing the systems and methods of the invention and are not to be understood as limiting in anyway.

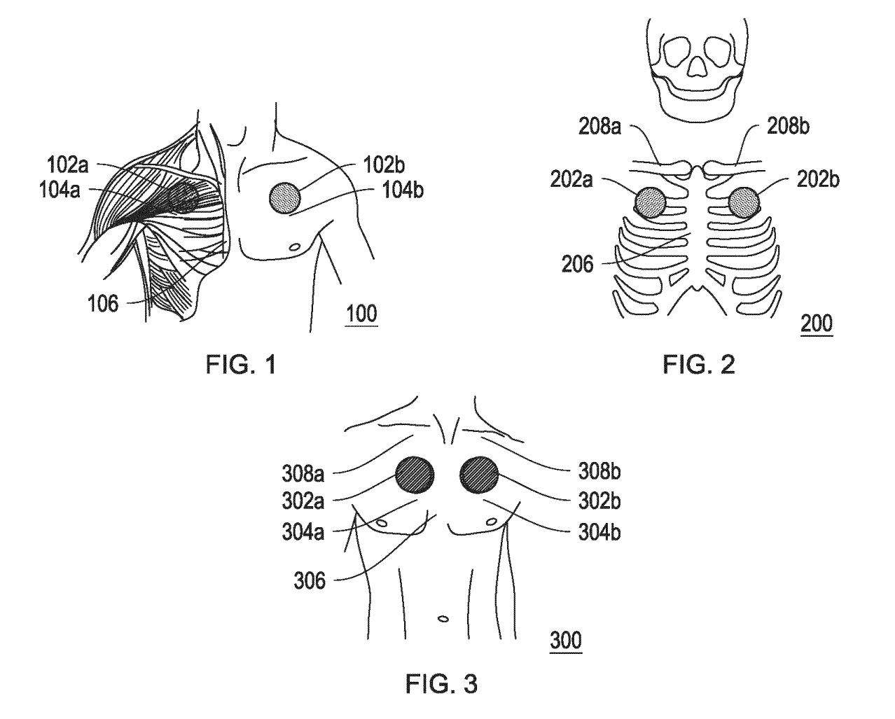

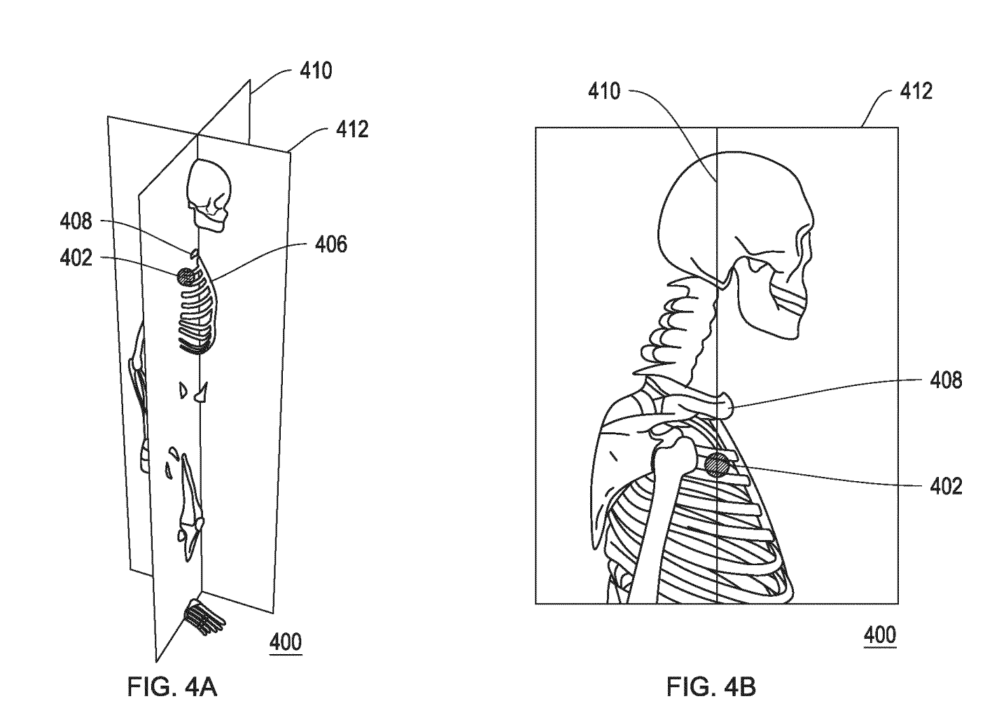

In particular, turning to FIGS. 1-4B, there are depicted vibrator location arrangements 100, 200, 300, and 400 on a human body, where different embodiments of the haptic device described herein may be attached. In particular, FIG. 1 depicts vibrator locations 102a and 102b with respect to the body's underlying musculature. FIG. 2 depicts vibrator locations 202a and 202b with respect to the body's underlying skeletal system. FIG. 3 depicts vibrator locations 302a and 302b with respect to the body's external surface. FIGS. 4A and 4B depict, respectively, an oblique view and a side view of vibrator location 402 with respect to the body's anatomical planes.

As depicted by FIG. 1, vibrator location arrangement 100 has vibrator locations 102a and 102b disposed symmetrically across the chest of the body. A first vibrator location 102a is located adjacent to a first pectoralis major muscle 104a, and similarly a second vibrator location 102b is located adjacent to a second pectoralis major muscle 104b. Both vibrator locations 102a and 102b are spaced away from the sternum 106.

As depicted by FIG. 2, vibrator location arrangement 200 has vibrator locations 202a and 202b disposed symmetrically across the chest of the body. A first vibrator location 202a is located inferior to a first clavicle bone 208a, and similarly a second vibrator location 202b is located inferior to a second clavicle bone 208b. Both vibrator locations 202a and 202b are spaced away from the sternum 206.

As depicted by FIG. 3, vibrator location arrangement 300 has vibrator locations 302a and 302b disposed symmetrically across a chest of the body. A first vibrator location 302a is located adjacent to a first pectoralis major muscle 304a and inferior to a first clavicle bone 308a; and similarly a second vibrator location 302b is located adjacent to a second pectoralis major muscle 304b and inferior to a second clavicle bone 308b. Both vibrator locations 302a and 302b are spaced away from a sternum 306.

As depicted by FIGS. 4A and 4B, vibrator location arrangement 400 includes vibrator location 402 disposed on a front-back coronal plane 410 of the body, inferior to a clavicle bone 408, and spaced away from a sternum 406. Vibrator location arrangements can also be symmetric across the left-right median plane 412. In particular, a second vibrator location can be disposed opposite vibrator location 402 such that the two locations are symmetric with respect to the left-right median plane 412.

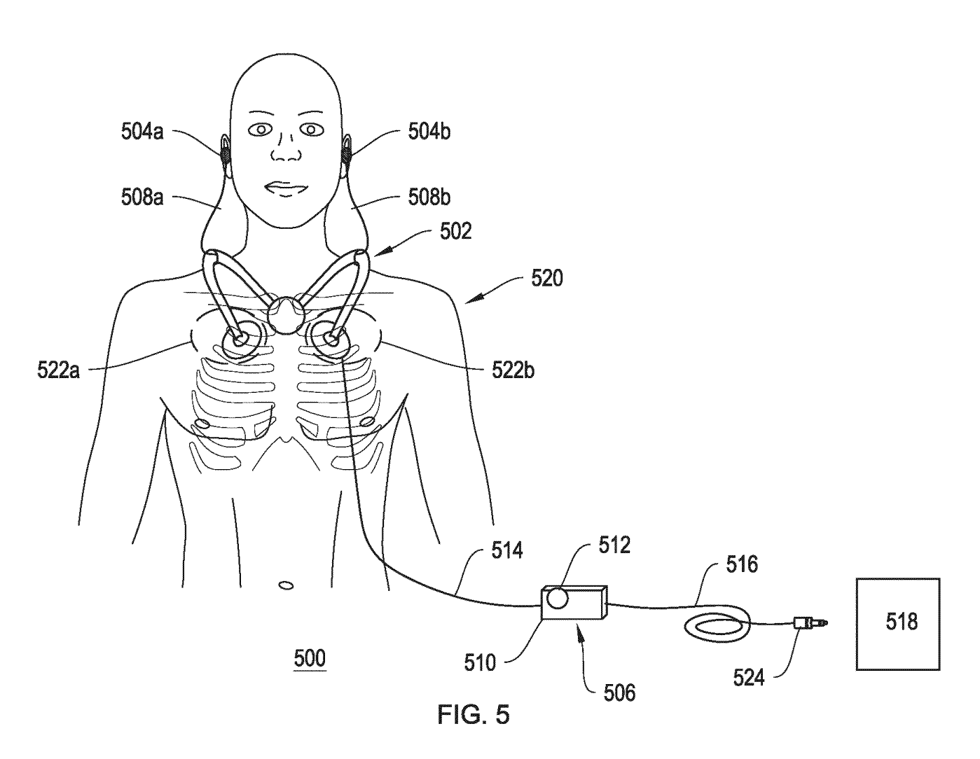

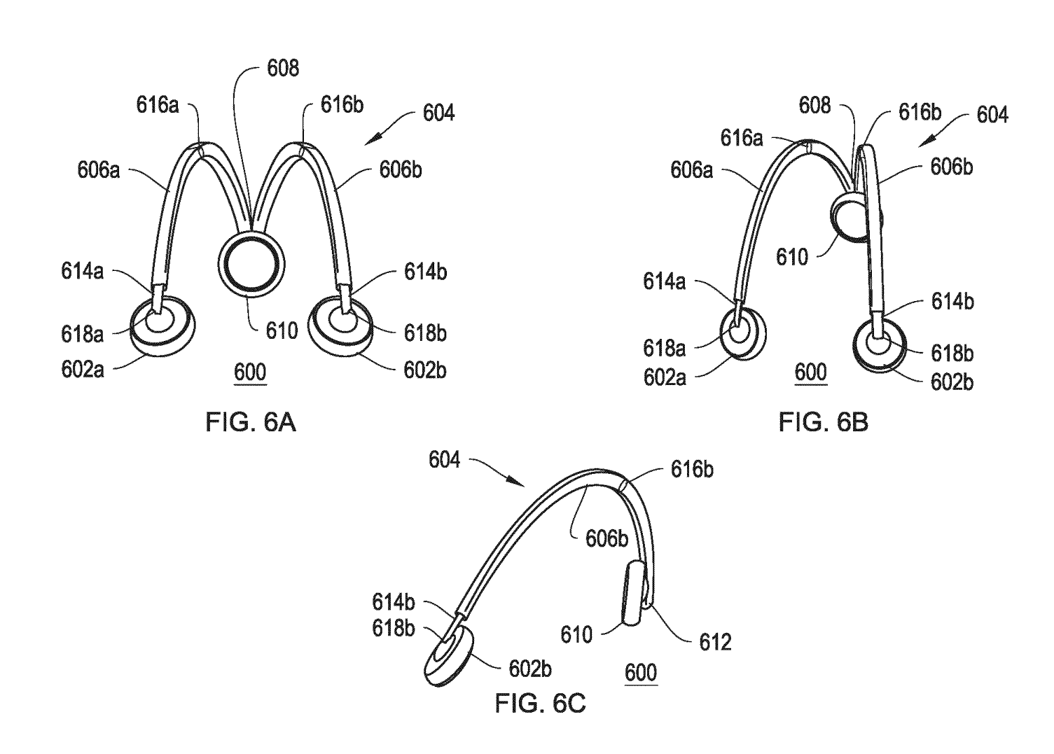

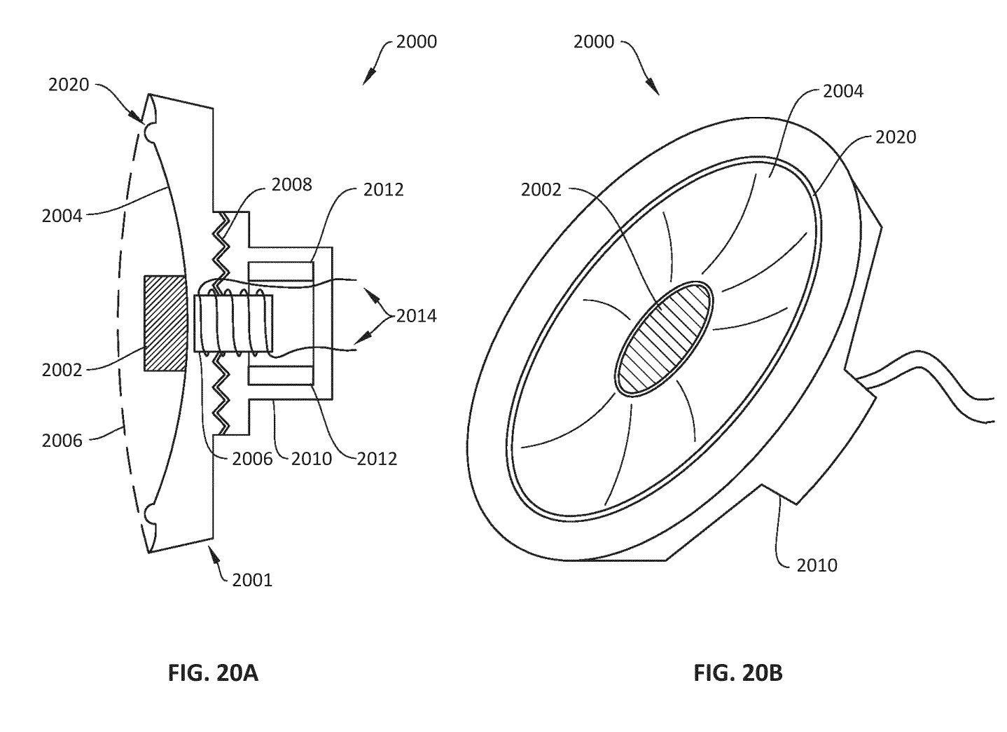

FIG. 5 depicts an exemplary vibration system 500 for experiencing acoustic and haptic data. The vibration system 500 is depicted on a human body 520 having vibrator locations 522a and 522b. The vibration system 500 includes a vibration device 502, optional audio speakers 504a and 504b, and a remote control 506. The vibration device 502 is described below in reference to FIGS. 6A-8. The optional audio speakers 504a and 504b can be any suitable audio device, such as an earphone, headphone, or neckphone, and can be attached by wires 508a and 508b to the vibration device 502. The optional audio speakers 504a and 504b may also be integrated with vibrators in the form of acoustic-haptic speakers, as described below in reference to FIGS. 20A-23. Alternatively, the audio speakers can be separate from the vibration device 502 or the user can opt to not have or use audio speakers in conjunction with the vibration device 502.

The depicted remote control 506 includes a housing 510 that supports a user input interface that may include a button, switch, or dial 512. User input information received through the user input interface may be used to control the generation and presentation of acoustic and haptic signals. For example, a dedicated switch may turn on or off the acoustic and haptic output together or separately, a dial may by used to adjust the volume and pitch of the acoustic output, or the intensity of the haptic output. The housing 510 can attach by wire 514 to the vibration device 502 and by wire 516 to any suitable data source 518 of audio data, such as a portable music device or video game console. For example, the remote control 506 may function as a game controller, and haptic signals may be selectively generated depending on if such haptic signals correspond to user input on the remote control 506. The wires 514 and 516 may each have an audio jack, such as the audio jack 524 attached to the end of the wire 516, for connecting to, respectively, the remote control 506 and the data source 518. Alternatively, the vibration device 502 can attach directly to a data source 518, which may also include an encased user input interface. In another alternative embodiment, the vibration device 502, the remote control 506, and the data source 518 can include, respectively, a wireless receiver, a wireless transceiver, and a wireless transmitter for communicating audio or haptic data.

In other embodiments, control signals for haptic data generation and output may be collected through any suitable user input interfaces or peripheral input devices similar to the remote control 506, which serves as an interface and provide data and control signals to the haptic system as well as to a computer or other suitable information processor. For example, a user input interface may include at least one of a button, scroll wheel, scroll button, switch, touch-sensitive membrane, touch-sensitive region on a device housing, touch screen, light pen, joystick, or motion sensor. Typical stand-alone input devices include a mouse, keyboard, touch screen light pen, graphics tablets, joysticks, and composite devices such as a video game controller. Such user input interfaces or input devices may receive discrete inputs such as key presses on a keyboard, or continuous input, such as a mouse's or a light pen's position. Such user input interfaces or input devices may have any number of degrees of freedom. Examples include a mouse with two-dimensional inputs, and three-dimensional navigation tools comprising motion sensors, accelerometers and gyroscopes.

FIGS. 6A-8 depict in more detail an illustrative embodiment of the vibration device 502. In particular, FIGS. 6A-6C depict, respectively, a front view, an oblique view, and a side view of an exemplary vibration device 600 having two vibrators 602a and 602b positioned by a support structure 604. The vibration device may include one ore more transducers for converting audio information in electrical signals into acoustic and haptic output signals. Although not shown directly, the vibration device 600 may also include processing circuitry for receiving user input information from the remote control 506, for processing such input information to control the generation and presentation of haptic signals, or for transmitting user input information through a wired connection or a wireless connection to another computing circuitry. Such processing circuitry may be housed within the remote control 506, within any of the vibrators 602a and 602b, or within a separate housing or support structure to which the vibrators 602a and 602b are attached to or connected to. Such processing circuitry may feature at least one of a pitch controller, a volume controller, a fade-in circuitry, an amplitude-ceiling circuitry, or a bass-enhancement circuitry. The pitch controller can modulate a pitch characteristic of audio information in an electrical signal. The volume controller can raise and lower an amplitude characteristic of an electrical signal, thus adjusting volume and/or intensity of acoustic and haptic signal output. The fade-in circuitry can gradually raise an amplitude characteristic of an electrical signal. The amplitude ceiling circuitry can reconfigure the electrical signal by imposing an upper limit on an amplitude characteristic of an electrical signal. The bass-enhancement circuitry can reconfigure the electrical signal by sampling a first electrical signal to create a sampled signal, modulating a pitch characteristic of the sampled signal to create a modulated sampled signal, and mixing the modulated sampled signal with the first electrical signal. The vibration system 600 can also feature, as part of or separately from the processing circuitry for processing input signals, a signal processing component capable of detecting that no electrical signal has been received for a preset amount of time, a power supply for powering the vibration system 600, and an automatic shut-off component that can turn off parts of or the entire vibration system 600, in response to the signal processing circuitry detecting that no electrical signal is being received from a preset amount of time. The processing circuitry may also feature a low frequency cross-over circuit capable of filtering through low frequency sound from an electrical signal and an amplifier capable of amplifying the electrical signal.

The vibrators 602a and 602b, described below in reference to FIG. 8, can include any suitable mechanism or transducers capable of transforming audio information in an electrical signal into vibration, such as an acoustic-haptic transducer or an off-balance rotor. Such transformation of audio information in an electrical signal relies on acoustic characteristics such as frequency range, pitch and volume to determine haptic signal output, and eliminates the need for transmitting separate electrical signals containing haptic information. Exemplary embodiments of acoustic-haptic transducers are described below in reference to FIGS. 20A-23. For example, such a transducer may include a speaker with a diaphragm and a mass element attached to a portion of the diaphragm, where the mass element is designed according to desired haptic output signals. The vibrators 602a and 602b attach to a support structure 604 that includes two curved harnesses 606a and 606b joined at a point of attachment 608. In particular, the vibrators 602a and 602b can attach to ends of the curved harnesses 606a and 606b, or alternatively to adjustable endpieces 614a and 614b nested within the ends of the curved harnesses 606a and 606b, via vibrator joints 618a and 618b. The curved harnesses 606a and 606b can have harness joints, respectively 616a and 616b. The point of attachment 608 can have an additional rear vibrator 610 or, alternatively, a rear cushion. The point of attachment 608 can also have an adductor joint 612.

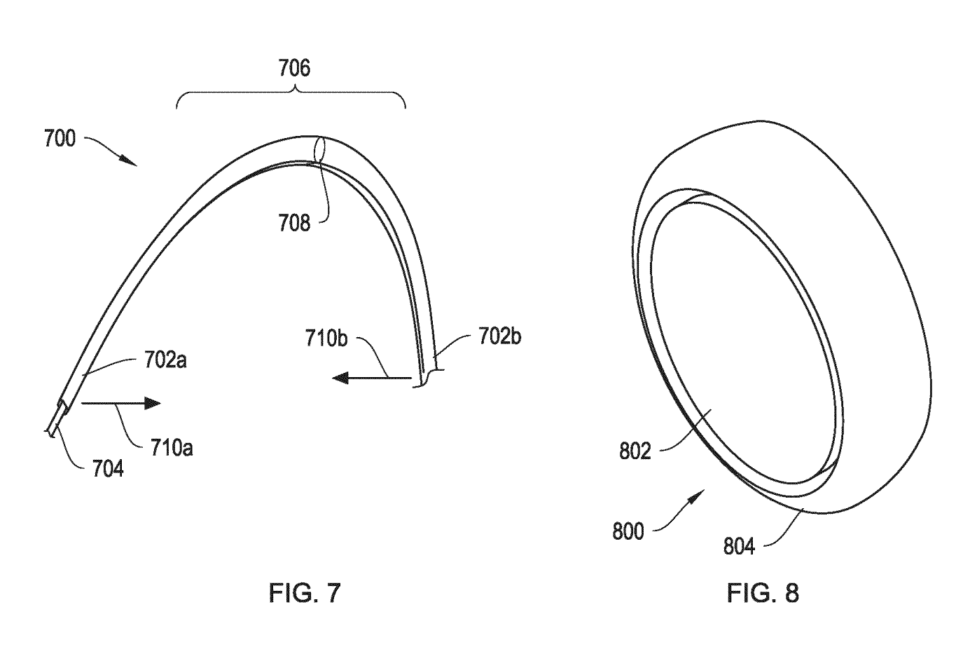

FIG. 7 depicts an exemplary curved harness 700 and adjustable endpiece 704 that can be used in the support structure 604. The curved harness 700 has two ends 702a and 702b configured to flex inwardly toward each other, as indicated by arrows 710a and 710b. The end 702a has an adjustable endpiece 704 nested within the curved harness 700. The adjustable endpiece 704 is capable of sliding in and out of the curved harness 700 to adjust a length of the curved harness 700. Between the ends 702a and 702b is a harness midsection 706, which can include a harness joint 708. The curved harness 700 and the adjustable endpiece 704 can be made of any suitably light, tensile material such as plastic, include padding such as fabric padding along their surfaces that are adjacent to the user to provide a more comfortable fit, and have external surfaces sufficiently tacky to prevent slippage when the surface rests against skin or fabrics typically used in clothing. Examples of suitable materials for their external surfaces include synthetic rubber and fabric used to cover audio speakers. The curved harness 700 can be between 10 inches and 13 inches in length and ¼ inches and 1 inch in width, while the adjustable endpiece 704 can be between 2 inches and 4 inches in length and ⅛ inches and ¾ inches in width.

FIG. 8 depicts an exemplary vibrator 800 that can be used in the vibration device 600. The vibrator 800 has a diaphragm 802 capable of vibrating in response to audio information contained in an electrical signal. The diaphragm 802 can be between 0.5 inches and 4 inches in diameter, with a preferred size dependent on the user's size. In particular, the diaphragm diameter can be approximately 20% of a lateral length measured from a first shoulder of the user to a second shoulder of the user. A thin cushion (not shown) can overlay the diaphragm 802 and be disposed between the diaphragm 802 and the user to soften the impact of the vibrations on the user. The thin cushion may be made of any suitable material that is sufficiently resilient and can provide padding, such as a silicone gel. An external surface of the diaphragm 802 can be any suitable material that is sufficiently tacky to prevent slippage when the external surface rests against skin or fabrics typically used in clothing. Examples of suitable materials include synthetic rubber, polyurethane, fabric used to cover audio speakers, and foam cushion used to cover headphone speakers. The surface material is typically between 1 mm and 5 mm in thickness. A cushion 804 can encircle the vibrator 800 to protect the edge of the diaphragm 802.

The vibrator 800 may be further include, or is connected to, processing circuitry for receiving, processing, or transmitting user input information for controlling haptic signal output through the vibrating diaphragm. In other embodiments of vibrators described herein, the vibrator may include at least one of an inertial transducer, an off-balance rotor, a tactile transducer, or a piezoelectric transducer. Similar to the exemplary vibrator 800, a surface of the vibrator can be made of at least one of synthetic rubber, foam cushion, polyurethane, speaker cover fabric, or silicone. A surface of the support structure can be made of at least one of synthetic tuber or speaker cover fabric.

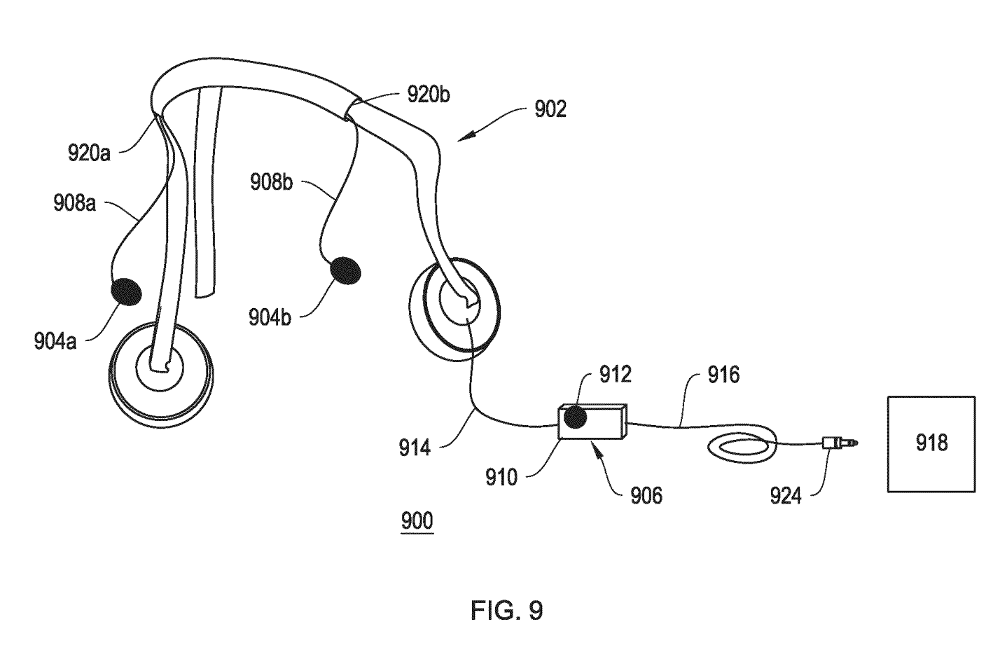

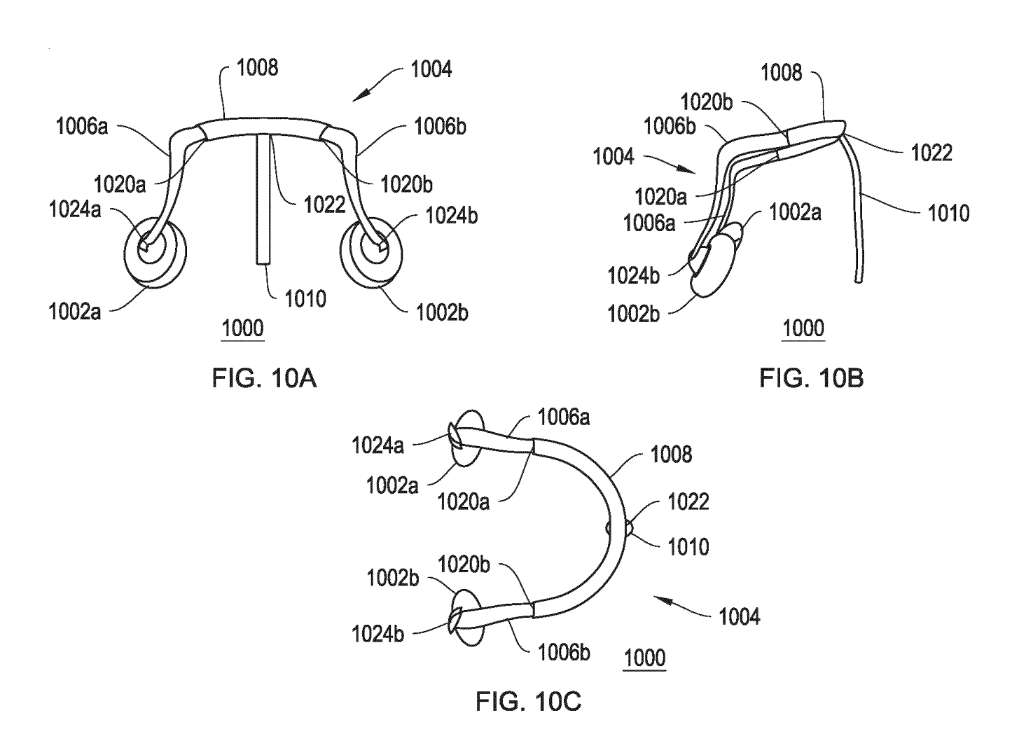

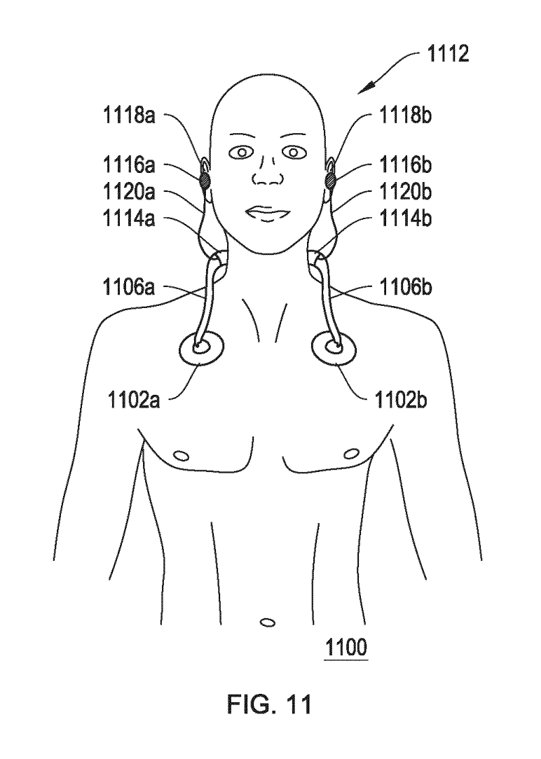

FIG. 9 depicts an exemplary vibration system 900 for experiencing audio and haptic data according to one aspect of the disclosure. The vibration system 900 includes a vibration device 902, optional audio speakers 904a and 904b, and a remote control 906. The vibration device 902 is described below in reference to FIGS. 10A-11. The optional audio speakers 904a and 904b can be any suitable audio device, such as an earphone, headphone, or neckphone, and can be attached by wires 908a and 908b to the vibration device 902 at joints 920a and 920b. The optional audio speakers 904a and 904b may also be integrated with vibrators in the form of acoustic-haptic speakers, as describe below in reference to FIGS. 20A-23. Alternatively, the audio speakers can be separate from the vibration device 902 or the user can opt to not have or use audio speakers in conjunction with the vibration device 902.

The depicted remote control 906 includes a housing 910 that supports user input interface such as a button, switch, or dial 912. The remote control 906 may also encase processing circuitry for processing input signal thus received through the user input interface for controlling the generation and presentation of audio and/or haptic signals. The housing attaches by wire 914 to the vibration device 902 and by wire 916 to any suitable source 918 of audio data, such as a portable music device or video game console. The wires 914 and 916 may each have an audio jack, such as the audio jack 924 attached to the end of the wire 916, for connecting to, respectively, the processor 906 and the data source 918. Alternatively, the vibration device 902 can attach directly to a data source 918, which may include a user input interface. The user input processing circuitry may be encased within the vibration device 902, within the data source 918, or separately in a dedicated housing. A user input interface connected to the processing circuitry may be housed together with or separately from the processing circuitry. In another alternative, the vibration device 902, the remote control 906, and the data source 918 can include, respectively, a wireless receiver, a wireless transceiver, and a wireless transmitter for communicating audio or haptic data.

FIGS. 10A-11 depict in more detail an illustrative embodiment of the vibration device 902. In particular, FIGS. 10A-10C depict, respectively, a front view, a side view, and a top view of an exemplary vibration device 1000 having two vibrators 1002a and 1002b positioned by a support structure 1004. The vibrators 1002a and 1002b, described above in reference to FIG. 8, can include any suitable mechanism capable of transforming audio information contained in an electrical signal into vibration. The vibrators 1002a and 1002b attach via vibrator joints 1024a and 1024b to a support structure 1004 that includes bent elements 1006a and 1006b joined at bent element joints 1020a and 1020b to a semi-circular element 1008. The semi-circular element 1008 attaches via a midpoint joint 1022 to a long element 1010 depending vertically from a midpoint of the semi-circular element 1008. The support structure 1004 can be made of any suitably light, tensile material such as plastic and have a surface sufficiently tacky to prevent slippage when the surface rests against skin or fabrics typically used in clothing. Examples of suitable materials include synthetic rubber and fabric used to cover audio speakers.

FIG. 11 depicts a vibration device 1100 being worn by a user 1112. A semi-circular element, which is not shown, is adapted to encircle a back of a neck of the user 1112 with a long element, also not shown, centered on an upper back of the user 1112. The bent elements 1106a and 1106b are adapted to attach to vibrators 1102a and 1102b and feature bends 1114a and 1114b having an angle configured to fit on a front shoulder of the user 1112. Accompanying audio speakers can be earbuds 1116a and 1116b attached by wires 1120a and 1120b to the vibration device 1100 and adapted to fit within ears 1118a and 1118b of the user 1112. In case of an acoustic-haptic transducer, audio output may also be broadcasted directly through the vibrators 1102a and 1102b.

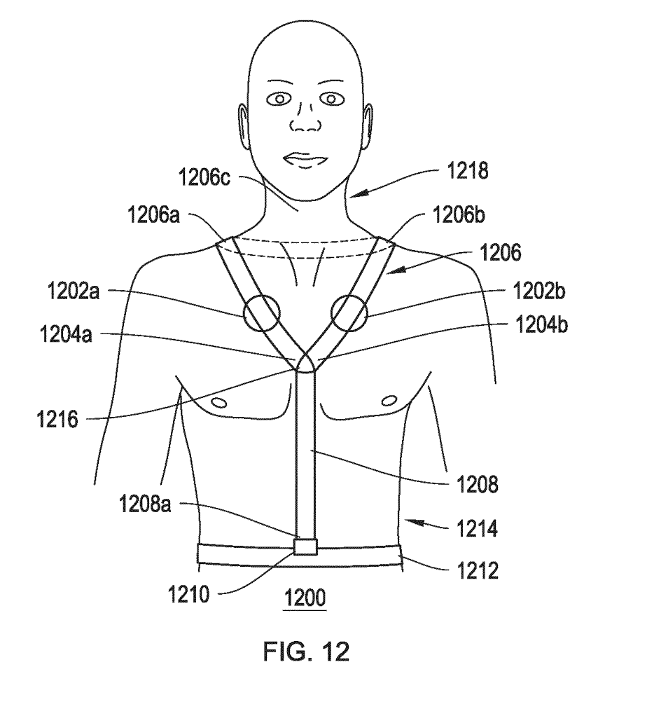

FIG. 12 depicts a front view of another exemplary vibration device 1200 being worn by a user 1214. The vibration device 1200 has two vibrators 1202a and 1202b supported by a loop of stretchable band 1206 that loops around the neck 1218 of the user. The stretchable band 1206 has two substantially symmetric front portions 1206a and 1206b, whose ends 1204a and 1204b meet at a point 1216 to form a V shaped structure adjacent to the chest of the user 1214, and a back portion 1206c that curves around the back of the neck 1218 of the user. The vibrators 1202a and 1202b, described above in reference to FIG. 8, attach to front portions 1206a and 1206b, respectively, and can include any suitable mechanism capable of transforming audio information contained in an electrical signal into vibration. The ends 1204a and 1204b connect to a vertical stretchable band 1208 that depends from the point 1216 to approximately the waist of the user. The stretchable bands 1206 and 1208 may be made of any suitable material that is sufficiently flexible and stretchable, such as elastic fabric. Vertical stretchable band 1208 may have a fastener 1210, attached to a free end 1208a. The fastener 1210 can be any suitable device capable of attaching to a waistband 1212 of clothing to hold the vibration device 1200 in place. Although not shown in FIG. 12, one or more motion sensors may be embedded in the vibrating device 1200 to collect user input in the form of position or motion information, and processing circuitry embedded in the vibrating device 1200 may process such motion information to control vibration output. For example, particular motion sequences may signal the user's desire to turn haptic signal output on or off. Some motion sequences, gesture, or posture may signal the user's desire to alter the intensity or other characteristics of the haptic output. In some embodiments, only one of the vibrators 1202a and 1202b produces haptic output while the other one is silent, depending on user input and, for example, events that occur in a virtual game. A user playing a virtual tennis game with right hand motions may feel a vibration on the right side through the vibrator 1202a whenever the tennis ball is hit by the user's racket, while a left-handed user may feel on the left side instead.

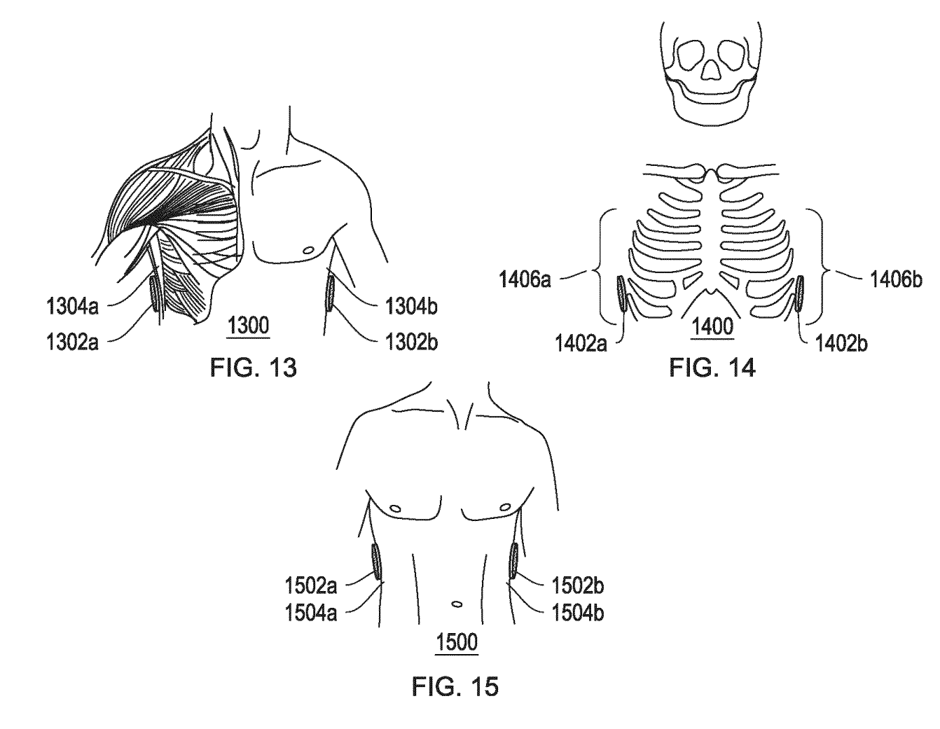

FIGS. 13-15 depict other vibrator location arrangements 1300, 1400, and 1500 on a human body. In particular, FIG. 13 depicts vibrator locations 1302a and 1302b with respect to the body's underlying musculature; FIG. 14 depicts vibrator locations 1402a and 1402b with respect to the body's underlying skeletal system; and FIG. 15 depicts vibrator locations 1502a and 1502b with respect to the body's external surface.

As depicted by FIG. 13, vibrator location arrangement 1300 has vibrator locations 1302a and 1302b disposed symmetrically across a torso of the body. A first vibrator location 1302a is located adjacent to a first abdominal external oblique muscle 1304a; and similarly a second vibrator location 1302b is located adjacent to a second abdominal external oblique muscle 1304b. Both vibrator locations 1302a and 1302b can be located on the front-back coronal plane 410, depicted in FIG. 4.

As depicted by FIG. 14, vibrator location arrangement 1400 has vibrator locations 1402a and 1402b disposed symmetrically across a torso of the body. A first vibrator location 1402a is located adjacent to a region 1406a of a rib cage which includes the third through tenth rib, known as costae verae III-X; and similarly a second vibrator location 1402b is located adjacent to a region 1406b of a rib cage which includes the third through tenth rib. Both vibrator locations 1402a and 1402b can be located on the front-back coronal plane 410, depicted in FIG. 4.

As depicted by FIG. 15, vibrator location arrangement 1500 has vibrator locations 1502a and 1502b disposed symmetrically across a torso of the body. A first vibrator location 1502a is located adjacent to a first abdominal external oblique muscle 1504a; and similarly a second vibrator location 1502b is located adjacent to a second abdominal external oblique muscle 1504b. Both vibrator locations 1502a and 1502b can be located on the front-back coronal plane 410, depicted in FIG. 4.

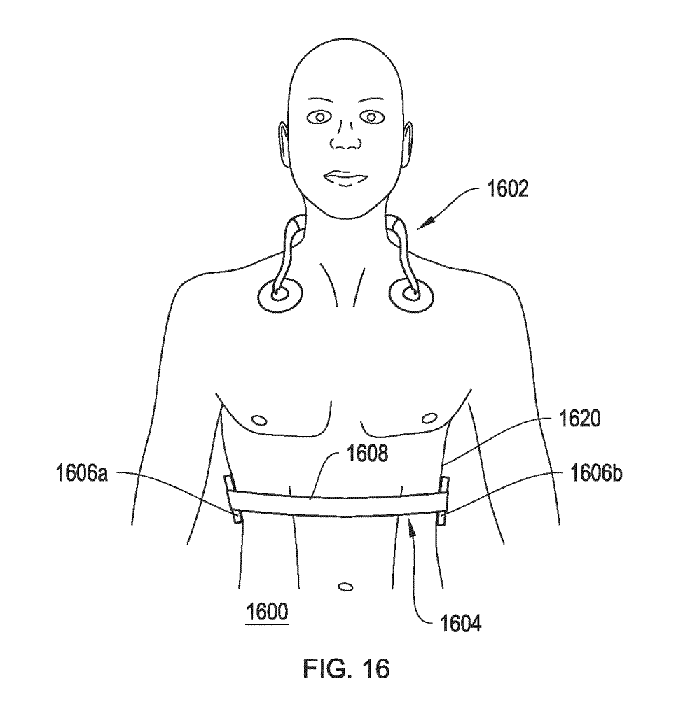

Vibrator location arrangements 1300, 1400, and 1500 may be implemented by the exemplary vibration device 1600 depicted in FIG. 16. Vibration device 1600 includes a chest vibration device 1602, which is similar to vibration devices 902, 1000, and 1100 described above and depicted in FIGS. 9-11, and a torso vibration device 1604. Alternatively, the user can opt to use the torso vibration device 1604 without the chest vibration device 1602. The torso vibration device 1604 includes a right vibrator 1606a and a left vibrator 1606b both attached to a stretchable band 1608 which encircles a torso 1620 of the human body. The vibrators 1606a and 1606b can include any suitable mechanism capable of transforming an electrical signal into vibration. The stretchable band 1608 can be made of any suitable material that is sufficiently flexible and stretchable, such as elastic fabric. The surface of the stretchable band 1608 is preferably adapted to reduce slippage when disposed on clothing or skin to prevent the torso vibration device 1604 from moving with respect to the torso 1620.

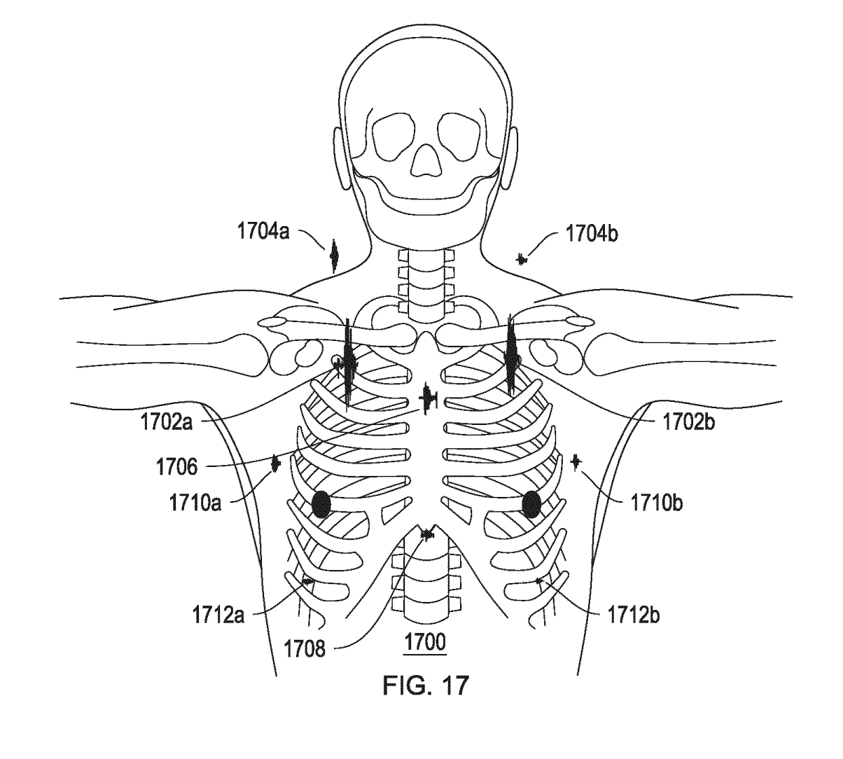

Other vibrator arrangements may also enhance a user's interaction with audio or visual content being presented. According to another aspect of the disclosure, one characteristic of a vibrator arrangement uses a pattern of vibrations measured on a human body's surface, called a surface vibration pattern. A natural surface vibration pattern occurs when the user generates sound, such as when the user is laughing or shouting. FIG. 17 depicts an exemplary natural surface vibration pattern 1700 of a user. In particular, FIG. 17 depicts pictorially the mechanical vibrations recorded at a variety of surface locations on the body's torso. A stethoscope was placed in contact with each surface location and coupled at its opposing end to a microphone, whose electronic signal output was recorded when the user was generating sound. Each waveform depicted in FIG. 17 represents the output recorded at that location and is sized according to the same scale to demonstrate the relative amplitudes of the surface locations. Other tests may also be suitable for measuring the surface vibrations on the body. In this example, the amplitudes are largest at symmetric pectoralis major muscle locations 1702a and 1702b, smaller at symmetric upper trapezius muscle locations 1704a and 1704b and a sternum location 1706, and smallest at a xyphoid process location 1708, underarm locations 1710a and 1710b, and sides of the ribcage locations 1712a and 1712b.

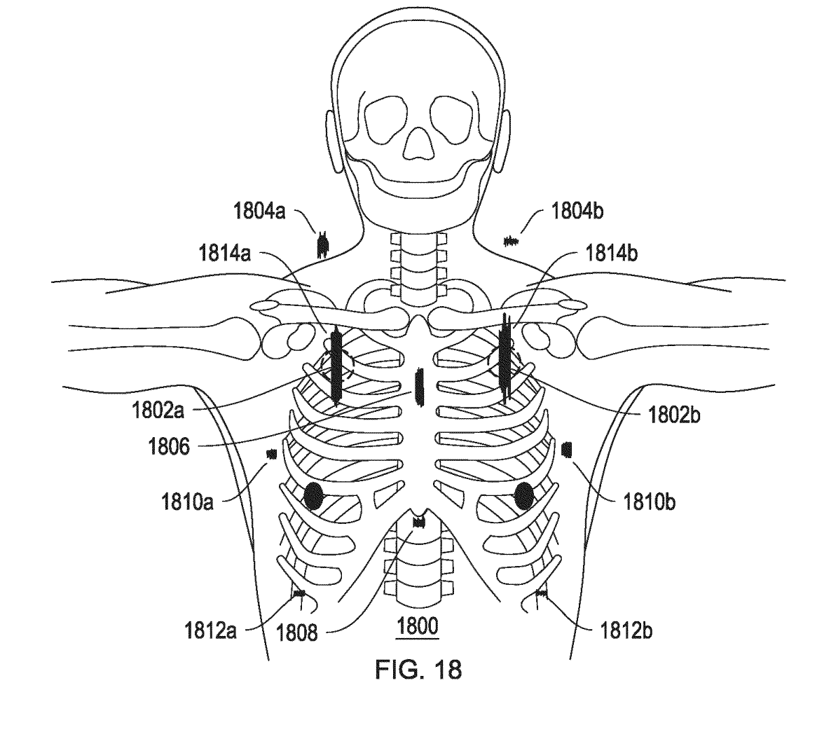

A vibrator location arrangement can induce a surface vibration pattern similar to the natural surface vibration pattern. This similarity in surface vibration patterns is preferably with respect to relative amplitudes across a variety of surface locations on the body. An exemplary vibrator-induced surface vibration pattern 1800, depicted in FIG. 18, has relative amplitudes across a set of surface locations that are similar to those of the natural surface vibration pattern 1700 depicted in FIG. 17. The amplitudes depicted in FIG. 18 were found in a similar manner to those of FIG. 17, except the microphone output was recorded when the user was using an exemplary vibration device instead of when the user was generating sound. In particular, the average amplitudes depicted in FIG. 18, like those of FIG. 17, are largest at symmetric pectoralis major muscle locations 1802a and 1802b, smaller at symmetric upper trapezius muscle locations 1804a and 1804b and a sternum location 1806, and smallest at a xyphoid process location 1808, underarm locations 1810a and 1810b, and sides of the ribcage locations 1812a and 1812b. The vibrators used to generate the vibrations of FIG. 18 were arranged in locations 1814a and 1814b, similar to vibrator location arrangements 100, 200, 300, and 400. Additional testing may be performed to determine other possible vibrator location arrangements that may create an immersive experience for the user.

Vibrator location arrangements can be symmetric with respect to the body's front-back coronal plane 410 and left-right median plane 412, depicted in FIG. 4. An arrangement of locations that is symmetric with respect to a plane may include locations that are on the plane, such as vibrator location 402, depicted in FIG. 4, which lies on the front-back coronal plane 410. Vibrator location arrangements symmetric with respect to the left-right median plane 412 include vibrator location arrangements 100, 200, 300, 1300, 1400, and 1500, depicted in FIGS. 1-3 and 13-15.

Vibrator location arrangements can space vibrators away from a sternum of the body, as depicted in vibrator location arrangements 100, 200, 300, 1300, 1400, and 1500 of FIGS. 1-3 and 13-15. Prolonged vibration of the sternum can irritate and inflame cartilage that connects the sternum to the ribs, creating a painful condition known as costochondritis.

A vibration system as described above may receive electrical signals containing audio, haptic, and other data from a variety of media and devices. Electrical signals containing audio information may also be transformed into haptic signals directly by the processing circuitry within the vibration system. Example media include music, movies, television programs, video games, and virtual reality environments. Example devices that can provide data and be used in conjunction with a vibration device include portable music players, portable video players, portable video game consoles, televisions, computers, and home entertainment systems. Exemplary vibration systems may connect to exemplary devices via an audio jack coupled to a wire, as depicted in FIGS. 5 and 9, or may contain a wireless receiver for wirelessly receiving signals from a device equipped with a wireless transmitter. In certain embodiments, the exemplary vibration systems may be included within a media device (e.g., portable electronic device) such that the media device forms part of the vibration system.

Using a vibration device in conjunction with a media device can enhance the user's interaction with the media by creating tactile sensations that synchronize with the data being presented by the media device. For example, soundtracks that accompany movies typically have, in addition to music and dialogue, sounds that accompany the action in the movie, such as a door slamming or an explosion. The vibration device, by transforming these sounds into vibrations, allows the user to simultaneously feel this action in addition to seeing and hearing it, which can create a more immersive experience for the user. This immersive effect can be especially desirable when the visual data is poor, for example portable devices with small video screens or computer monitors with relatively low resolution. As another example, the user's perception of music may be enhanced by the vibration device, which can create a tactile sensation synchronized with the music by using the same data source as the audio speakers. This enhancement can be especially desirable for experiencing the low frequency component, also known as bass.

The vibration device can include one or more transducers capable of transforming audio information included in electrical signals into both acoustic and haptic signals for enhancing the content perceived by the user or allowing the user to modify the content. The vibration device can also include processing circuitry for receiving and processing user input information for directly or indirectly controlling the transformation of audio information into haptic signals, and any further adjustment, modulation, reconfiguration of such haptic signals in response to receiving user input information. Processing circuitry may be housed externally to the vibration device, as depicted in the embodiments of FIGS. 5 and 9, or internally within the vibration device.

Exemplary control functions of processing circuitry include pitch control, volume control, fade-in, amplitude-ceiling, auto shut-off, channel separation, phase-delay, and bass enhancement, whose implementations are well-known to one skilled in the art. Pitch control allows a user to increase or decrease the overall frequency of an electrical signal. Volume control allows a user to increase or decrease the overall amplitude of an electrical signal. Fade-in gradually increases the amplitude of the beginning of an electrical signal to lessen the initial impact of vibrations on a user. Amplitude-ceiling creates an upper bound on the magnitude of the amplitude of the electrical signal to prevent the user from experiencing excessively intense vibrations. Auto shut-off turns off the processing circuitry to conserve power without receiving input from the user and when an electrical signal has not been received for a preset amount of time. Channel separation separates a stereo or multichannel signal into its component channels. Phase-delay delays a signal sent to a second vibrator with respect to a signal sent to a first vibrator to give the user the impression the sound originated from a location closer to the first vibrator than the second vibrator. Bass enhancement increases the amplitude of the bass component of an electrical audio signal relative to the rest of the signal. One or more of the exemplary control functions of processing circuitry may be activated based on, directly or indirectly, user input information.

Examples of multichannel signals that can be separated by processing circuitry include stereo sound, surround sound, and multichannel haptic data. Stereo sound typically uses two channels. Channel separation circuitry can separate a stereo sound two-channel electrical audio signal into a left channel signal and a right channel signal intended to be experienced by the user from, respectively, a left-hand side and a right-hand side. Multichannel electrical audio signals, such as those used in 5.1 and 6.1 surround sound, can similarly be separated, and typically contain rear channel signals intended to be experienced by the user from the rear. Channel separation circuitry can also separate multichannel haptic data, such as those used with video games or virtual reality environments, that similarly contain data intended to be experienced by the user from a specific direction. Such channel separation function may be activated based on user input information. In one example, a user can explicitly indicate which channel is to be produce haptic data. In another example, processing circuitry may separate audio channels to produce multichannel haptic data, where a haptic channel is only activated if motion sensors in the corresponding acousto-haptic transducer detect user motion information.

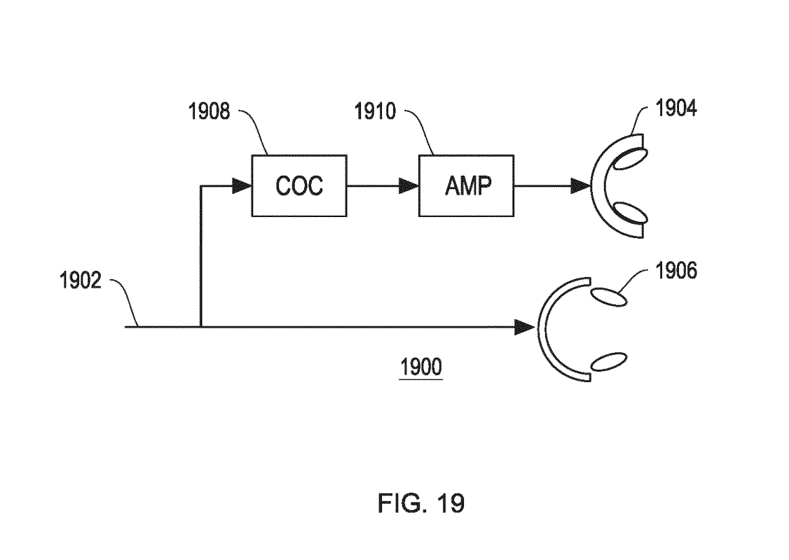

Multiple implementations of bass enhancement are possible. An exemplary processing circuitry 1900 for bass enhancement is depicted in FIG. 19. An electrical signal is received at an input 1902 for transmitting to a vibration device 1904 and audio speakers 1906. A low frequency cross-over circuit 1908 can filter through only the bass component of the received electrical signal, whose overall amplitude is increased by an amplifier 1910 before reaching a vibration device 1904. In this embodiment of the disclosure, acoustic and haptic signal outputs are presented separately through audio speakers 1906 and vibration device 1904 and bass enhancement is applied to the haptic signal only. In some embodiments, an acoustic-haptic transducer may be used, with a mass element disposed on the diaphragm of a speaker.

Another bass enhancement implementation increases the bass component without filtering out the rest of a signal. Processing circuitry can sample a received electrical signal to create a sampled signal, modulate the pitch of the sampled signal to create a modulated sampled signal, and mix the modulated sampled signal with the received electrical signal to create a signal for the vibration device. The modulation of the pitch preferably lowers the pitch of the sampled signal to increase the bass component of the signal received by the vibration device. The user may also control the degree of bass enhancement by lowering the overall frequency of a signal using pitch control.

Processing circuitry can send different signals, each based on an electrical signal received from a source of data, to different destinations. The different destinations can include audio speakers, vibrators, or acousto-haptic transducers that are differentiated by their position relative to the body. For example, the electrical signals generated by channel separation can be transmitted to speakers or vibrators having appropriate positions relative to the body. In particular, signals intended to be experienced from the left can be sent to speakers, vibrators, or acousto-haptic transducers left of the left-right median plane, signals intended to be experienced from the right can be sent to speakers, vibrators, or acousto-haptic transducers right of the left-right median plane, signals intended to be experienced from the rear can be sent to speakers, vibrators, or acousto-haptic transducers rear of the front-back coronal plane, and signals intended to be experienced from the front can be sent to speakers, vibrators, or acousto-haptic transducers anterior of the front-back coronal plane. Exemplary vibration device 600, depicted in FIG. 6, can include a rear vibrator 610 for receiving a rear channel generated by channel separation processing circuitry. Exemplary torso vibration device 1604, depicted in FIG. 16, can include a left vibrator 1606b and a right vibrator 1606a for receiving, respectively, a left channel and a right channel generated by channel separation processing circuitry. Each vibrator discussed herein may be capable of producing both acoustic and haptic signals.

Processing circuitry can also combine multiple functions and can apply different sets of functions to electrical signals depending on their destinations. Preferably, signals sent to vibrators have undergone bass enhancement. For example, the embodiment 1900 depicted in FIG. 19 applies a bass enhancement implementation 1908 and 1910 to an electrical signal destined for a vibration device 1904, and applies a direct coupling between the input 1902 and an electrical signal destined for audio speakers 1906. Different speakers and vibrators may also each have individual controllers to allow the user more flexibility in controlling the immersive experience.

Once the electrical signals have been processed, the modified electrical signals can be transmitted to a vibration device, exemplified by vibration devices 502, 902, 1200, and 1600 depicted in, respectively, FIGS. 5, 9, 12, and 16. The vibration devices have vibrators capable of transforming received electrical signals containing audio information into mechanical movement. The mechanical movement can take the form of a vibration whose amplitude and frequency match those of the received electrical signal. In a preferred embodiment, the vibrator has a flat or concave surface, called a diaphragm, that vibrates to create the matching mechanical movement. Examples of mechanisms capable of generating vibration in response to an electrical signal include an inertial transducer, a piezoelectric transducer, a tactile transducer, and a motor with an off-balance rotor.

The support structure of the vibration device can serve multiple purposes for insuring the vibration device imparts an immersive experience to the user. The support structure can dispose vibrators in vibrator location arrangements and insure the vibrators can transfer vibration to the user. Other support structure qualities include a comfortable fit, ease of use, and an inconspicuous presence when worn.

The support structure of the vibration device can be configured to position vibrators according to vibrator location arrangements, such as those described above and in reference to FIGS. 1-4 and 13-15. For example, the support structure of the vibration device 502 depicted in FIG. 5 positions vibrators in vibrator locations 522a and 522b. Similarly, the support structure 604 depicted in FIGS. 6A-6C can position the vibrators 602a and 602b according to vibrator location arrangements 100, 200, 300, and 400 depicted in FIGS. 1-4. The user can also adjust the positioning of the vibrators by using the adductor joint 612 to adjust the harnesses 606a and 606b laterally and the adjustable endpieces 612a and 612b to adjust the length of the harnesses 606a and 606b. The support structure 1004 depicted in FIG. 10 and the suspenders 1204 depicted in FIG. 12 can position vibrators, respectively, 1002a and 1002b, and 1202a and 1202b, also according to vibrator location arrangements 100, 200, 300, and 400 depicted in FIGS. 1-4. The stretchable band 1608 of the torso vibration device 1604 depicted in FIG. 16 can position vibrators 1606a and 1606b according to vibrator location arrangements 1300, 1400, and 1500.

The support structure can also be configured to align a diaphragm 802 of a vibrator 800, depicted in FIG. 8, substantially parallel to a surface of the user at the vibrator location to insure that as much as possible of the diaphragm 802 is in contact with the user. For example, the support structure 604 depicted in FIGS. 6A-6C has vibrator joints 618a and 618b capable of adjusting the angle at which the vibrators 602a and 602b are oriented. The user can adjust the vibrators 602a and 602b to an angle that orients the diaphragms of the vibrators 602a and 602b substantially parallel to the surface of the chest of the user 520 at vibrator locations 522a and 522b depicted in FIG. 5. Similarly, the support structure 100 depicted in FIGS. 10A-10C has vibrator joints 1020a and 1020b capable of adjusting the angle at which the vibrators 1002a and 1002b are oriented.

The support structure can also be configured to push the vibrators against the body to insure the user can sense the vibrations of the vibrators. Support structures that include tensile elements can have rigidity sufficient to push the vibrators against the body. For example, the support structure 604 depicted in FIGS. 6A-6C has curved harnesses 606a and 606b configured to flex inwardly, which pushes the vibrators 602a and 602b against the body. In another example, the support structure 1004 depicted in FIG. 10 includes a long element 1010 attached to a semi-circular element 1008. The angle between the long element 1010 and a plane of the semi-circular element 1008 is preferably sufficiently acute to push the vibrators 1002a and 1002b against the body. Other embodiments contain non-tensile support structures configured to push the vibrators. For example, support structures that include stretchable bands, such as the suspenders 1204 depicted in FIG. 12 and the stretchable band 1608 depicted in FIG. 16, can be made of an elastic material. The elasticity of the stretchable bands pushes the vibrators 1202a, 1202b, 1606a, and 1606b against the body.

The support structures described herein can be configured to fit snugly without being too compressive on the body, are straightforward to put on over the shoulders or around the torso, and can be worn underneath clothing without significantly altering the profile of the clothing.

Embodiments of the vibration device may also be foldable to facilitate storage and portability of the device. Vibration device support structures that can be made of fabric, such as the suspenders 1204 depicted in FIG. 12 and the stretchable band 1608 of the torso vibration device 1604 depicted in FIG. 16, can easily fold into a myriad of shapes. Vibration devices made of a more rigid material can have joints or hinges for facilitating folding.

For example, exemplary vibration device 600 depicted in FIGS. 6A-6C can have joints 612, 616a, and 616b adapted for folding up the vibration device 600. In particular, the adductor joint 612 can adduct the two harnesses 616a and 616b together; and the harness joints 616a and 616b can allow the vibrators 602a and 602b, respectively, to fold towards the point of attachment 608. The joints 612, 616a, and 616b preferably have one degree of freedom and can be spring-loaded.

Similarly, exemplary vibration device 1000 depicted in FIGS. 10A-10C can have joints 1020a, 1020b, and 1022 adapted for folding the vibration device 1000 into substantially the same plane as the semi-circular element 1008. In particular, the bent element joints 1020a and 1020b can allow the bent elements 1006a and 1006b to fold upward and inward; and the midpoint joint 1022 can allow the long element 1010 to fold upward and inward. The joints 1020a, 1020b, and 1022 preferably have one degree of freedom and can be spring-loaded.

FIGS. 20A and 20B depict side and perspective views of an acousto-haptic transducer 2000, according to an illustrative embodiment of the invention. Transducer 2000 includes a mass element 2002 coupled to a speaker 2001. The speaker 2001 may be an acoustic transducer disposed within a housing 2010 and includes a voice coil 2006 suspended in a magnetic field generated by magnetic assembly 2012. The voice coil 2006 includes a length of wire wound about a core and capable of generating a magnetic field when electric current is passed through leads 2014. The voice coil 2006 is attached to the housing 2010 by a spider 2008. The speaker 2001 further includes a diaphragm disposed on the voice coil 2006 and configured to couple to the housing 2010 via flexible rim 2020. The diaphragm 2004 is capable of vibrating in response to an electrical signal. The diaphragm 2004 can be between 0.5 inches and 4 inches in diameter, with a preferred size dependent on the user's size. A thin cushion (not shown) can overlay the diaphragm 2004 and be disposed between the diaphragm 2004 and the user to soften the impact of the vibrations on the user. The thin cushion may be made of any suitable material that is sufficiently resilient and can provide padding, such as a silicone gel. An external surface of the diaphragm 2004 can be any suitable material that is sufficiently tacky to prevent slippage when the external surface rests against skin or fabrics typically used in clothing. Examples of suitable materials include synthetic rubber, polyurethane, fabric used to cover audio speakers, and foam cushion used to cover headphone speakers. The surface material is typically between 1 mm and 5 mm in thickness. A cushion can encircle the transducer 2000 to protect the edge of the diaphragm 2004.

During operation, an electrical signal (typically broadband oscillating signals) containing at least one of audio and haptic or tactile information may be transmitted to the voice coil 2006 through leads 2014. The electrical current flowing through the voice coil 2006 creates a Lorentz force between the voice coil 2006 solenoid and the magnetic assembly 2012. In certain embodiments the magnetic assembly 2012 is fixed and attached to the housing 2010 and therefore, in response to the Lorentz force, the voice coil 2006 may start to oscillate. The spider 2008 may damp this oscillation allowing the speaker to have a high fidelity across a full-range of frequencies. The voice coil 2006 may serve as an actuator moving the mass element 2002 along with the diaphragm. The mass element 2002 advantageously allows a user to adjust the resonant frequency of the transducer 2000 by varying the mass of the mass element 2002. In particular, the transducer may have a resonant frequency range that lies within the range of frequencies of the electrical signal. This resonant frequency range may be moved about the spectrum by adjusting one or more characteristics of the mass element, including its mass. When the voice coil 2006 is excited by signals at a frequency in the resonant frequency range, the transducer 2000 will vibrate to produce haptic signals. A user can place the transducer 2000 in close proximity to skin to perceive tactile sensations generated by these haptic signals.

In certain embodiments, the mass element 2002 may be formed from a rigid material having a high density. Alternatively, the mass element 2002 may include non-rigid material alone or in combination with rigid material. The non-rigid materials may include, without limitations, silicon. The mass element 2002 may be formed from a metal or a metal-alloy. The mass element 2002 may be formed from at least one of copper, nickel, silver, gold, manganese, aluminum, and titanium. The mass element 2002 may be formed from any suitable rigid material without departing from the scope of the invention. In certain embodiments, the mass element 2002 may be formed from a material selected such that the mass, footprint, height, and/or volume of the mass element 2002 are suitable for combining with a speaker 2001 having a predetermined dimension.

In one example, the speaker 2001 may be a commercially available speaker having a diaphragm, voice coil and housing with pre-determined dimensions. In such an example, the mass element 2002 may need to have a particular dimension and shape, and consequently, the mass element 2002 may be formed from a material to provide a mass within the constraints imposed by the pre-determined dimensions of the commercially-available speaker. The mass of the mass element 2000 may be about 2 g. In certain embodiments, the mass of the mass element 2000 may be from about 0.1 g to about 20 g. In other embodiments, the mass may range from about 1 g to about 4 g. The mass of the mass element may be less than or equal to about 0.1 g, 0.25 g, 0.5 g, 1 g, 1.5 g, 2 g, 2.5 g, 3 g, 3.5 g, 4 g, 4.5 g, 5 g, 10 g, 15 g, or 20 g.

Generally, as the mass of the mass element 2002 increases, the resonant frequency of the transducer decreases. Consequently, the mass of the mass element 2002 may be selected to generate haptic signals within particular frequency ranges. In addition to the mass of the mass element 2002, the mass of the speaker 2001 and housing 2010 may be relevant towards the performance of the transducer 2000. In particular, the mass of the entire transducer 2000 may affect the amplitude of vibrations in the resonant frequency range. Generally, the greater the mass of the transducer 2000, the lower the amplitude.

Generally, the mass element 2002 may be sized and shaped as suitable for a desired application. The mass element 2002 may have a circular cross-section and may be disk-shaped, hemispherical, conical, or frusto-conical. The mass element 2002 may have a rectangular cross-section and may be cuboidal, or pyramidal shaped. In one embodiment the mass element 2002 has a similar shape and dimensions as that of a U.S. 1 cent coin. In particular, the mass element 2002 may be disk-shaped and about 0.75 inches (19.05 mm) in diameter and about 0.061 inches (about 1.55 mm) in thickness. Generally, the shape of the mass element 2002 may be selected based on the shape of the underlying diaphragm 2004 or voice coil 2006 or housing 2010. The mass element 2002 may be selected such that its footprint (cross section area) is small enough so as not to affect the acoustic characteristics of the diaphragm. Generally, the larger the footprint of the mass element 2002, the lower the amplitude of the sound produced by the transducer 2000. Therefore, it may be desirable to have a mass element 2002 with a footprint small enough so that the diaphragm 2004 can produce audible sound. In one embodiment, the ratio between the diaphragm 2004 and the cross-section surface area of the mass element 2002 may be about four.

In certain embodiments, transducer 2000 may include an optional and removable dust cap 2016. In such embodiments, the dimensions of the mass element 2002 may be selected such that during operation (when the mass element 2002 moves towards and away from the cap 2016) the mass element 2002 does not make contact with the cap 2016. In such embodiments, the haptic signals are transmitted to the user through inertial vibration of the housing 2010 of the transducer. In certain embodiments, the transducer may be configured to provide an alarm signal to a user when the transducer is malfunctioning or is being incorrectly or inappropriately used. The mass element 2002 may be configured to make contact with the cap 2016 during operation. In such an embodiment, a user may place the cap 2016 in contact with skin and may feel the mass striking the inside of the cap 2016 during use. Such haptic signals may be stronger than other signals and consequently may signal an alarm to the user.

The mass element 2002 may be disposed near the center region of the diaphragm 2004. The mass element may be attached away from the center region on the diaphragm 2004. In certain embodiments, transducer 2000 includes a plurality of mass elements 2002, having the same or different masses sizes and shapes, stacked on top of each other at one or more locations on the diaphragm 2004. In one such embodiment, the transducer 2000 includes a plurality of mass elements 2002 located at a two or more locations on the diaphragm 2004. In such an embodiment, the transducer 2000 may have more than one adjustable resonant frequency range, and when vibrated at one or more of these frequencies, the transducer 2000 may generate haptic signals. In certain embodiments, a plurality of mass elements 2002 having different masses, based on their location on the diaphragm 2004, may be capable of transverse vibrations in addition to longitudinal vibrations. In such embodiments, a user may selectively control which of the plurality of mass elements 2002 to resonate.

In certain embodiments, the mass element 2002 may be attached to the diaphragm 2004 using an adhesive such as glue. In certain embodiments, the diaphragm 2004 may have an opening in the center region. In such embodiments, the mass element 2002 may be attached to the voice coil 2006 and/or a portion of the diaphragm 2004 surrounding the opening. In certain embodiments, the mass element 2002 may be permanently attached to the diaphragm 2004 and/or voice coil 2006. In certain other embodiments, the mass element 2002 may be removably attached or removably coupled to the diaphragm 2004 and/or voice coil 2006. In such embodiments, the mass element 2002 may be attached to the diaphragm 2004 and/or voice coil 2006 by a temporary or removable adhesive. In other embodiments, the mass element 2002 may be attached to one or more portions of the housing 2010. In such embodiments, the mass element 2002 may be attached to an inside or outside portion of the housing. In one embodiment, the mass element includes one or more components associated with the housing 2010. For example, if a diaphragm 2004 is directly connected to (e.g., glued) to the frame of a housing module, the magnet and/or the frame of the speaker may act as the resonant mass. Thus, various components of a transducer system may be configured, shaped, connected, weighted, and/or arranged in a selected way as to provide a resonant mass for the transducer system.

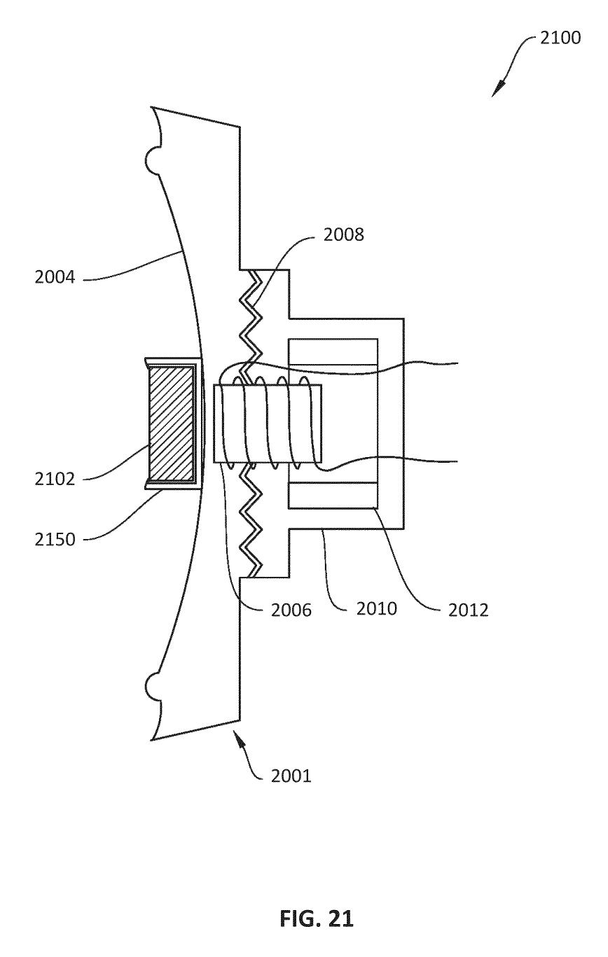

In certain embodiments, as depicted in FIG. 21, mass element 2002 may be coupled, indirectly, to the diaphragm 2004 and/or voice coil 2006 via a holder 2150. In particular, FIG. 21 depicts a side view of an acousto-haptic transducer 2100, according to an illustrative embodiment of the invention. Transducer 2100 may be similar to transducer 2000 of FIG. 20 in many respects, however, mass element 2100 (which may be similar to mass element 2000) is removably coupled to the speaker 2001 using a holder 2150. The mass element 2100 may be snapped into the holder 2150 to allow the transducer 2100 to suitably operate as a haptic transducer. As desired, haptic functionality may be reduced by snapping off mass element 2100 from its holder 2150. The holder 2150 may be formed from any suitable material, and sized and shaped as desired without departing from the scope of the invention. In certain embodiments, the holder 2150 may be configured to hold a plurality of mass elements 2002.

Transducers 2000 and 2100 may be configured with a plurality of mass elements 2000 or 2100. A user may advantageously add or remove one or more mass elements 2000 or 2100 to adjust and modify the resonant frequency range of the transducer. In certain embodiments, the mass elements 2000 or 2100 may be stacked on top of each other and attached together by adhesive. In other embodiments, the mass elements 2000 or 2100 may be stacked together and snapped onto holder 2150. Each of the plurality of mass elements 2000 or 2100 may have the same or different dimensions, shape, density, mass, material and other characteristics.

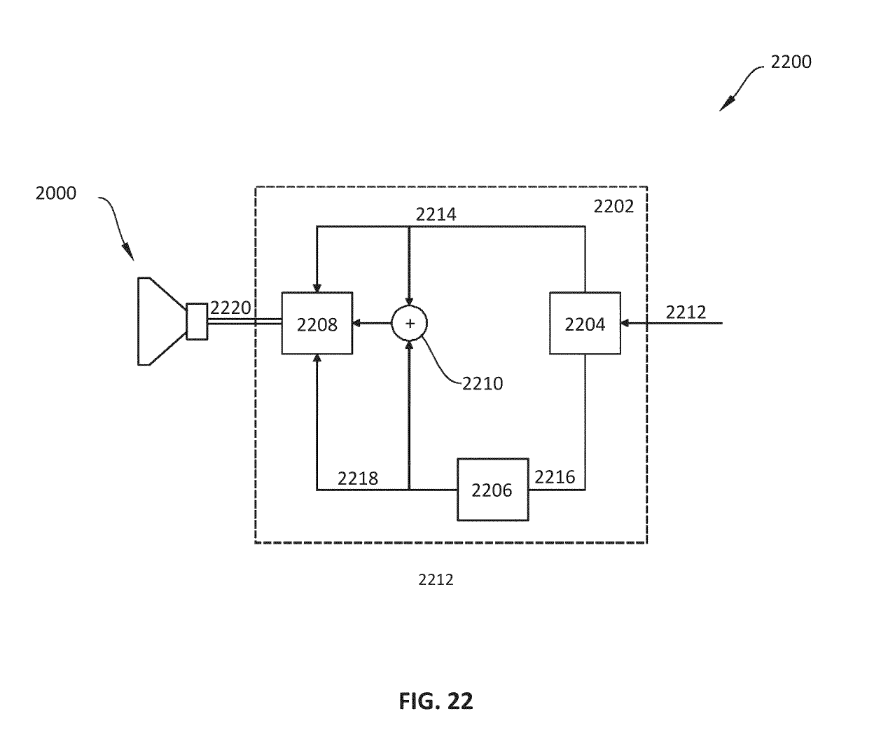

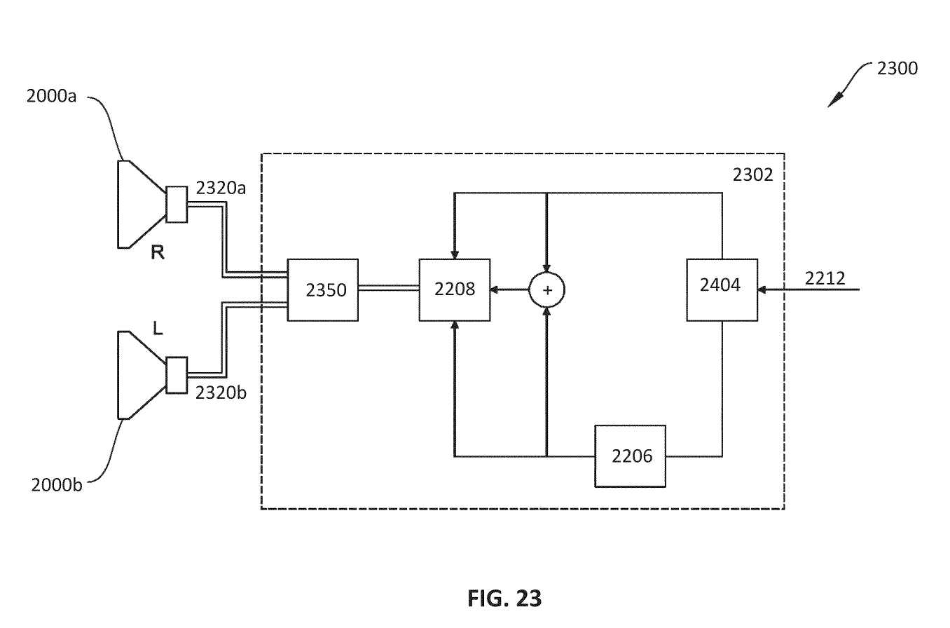

Generally, the speakers 2001 may be any audio producing device. For example, the audio speakers 2001 can be any suitable audio device, such as a loudspeaker, tweeter, subwoofer, earphone, headphone, or neckphone, and the like. The speaker 2001 and the mass element 2002 are enclosed within housing 2010. The housing 2010 may encase the speaker 2001, mass element 2002 and/or other processing circuitry, as will be described in more detail below with reference to FIGS. 22 and 23. The housing 2010 may be configured to support user control interfaces such as a button, switch, dial or screen. The housing 2010 may be adapted to attach (directly or indirectly) at least by wire leads 2014 to any suitable data source of audio or haptic data, such as a portable music device or video game console. In another alternative embodiment, housing can include an on-board power source, and a wireless receiver, a wireless transceiver, and a wireless transmitter for communicating audio or haptic data.

As noted earlier, during operation electrical signals from a data source cause the transducer 2000 or 2100 to generate acoustic and haptic signals. In certain embodiments, a controller and/or other processing circuitry may be disposed between the data source and the transducer 2000 or 2100 to enhance the signal.

FIG. 22 is a block diagram of an acousto-haptic transducer coupled to processing circuitry or a controller, according to an illustrative embodiment of the invention. In particular, FIG. 22 shows a system 2200 including an acousto-haptic transducer 2000 connected to a controller 2202. Electrical signals 2212 containing audio information are fed into the controller 2202, and specifically into filter 2204. Splitter 2204 splits the signal 2212 into a first portion 2214 having a first range of frequencies and a second portion 2216 having a second range of frequencies. Often times, haptic information may be contained in the low frequency region of an incoming audio signal 2212. The splitter 2204 may include a combination of one or more high-pass, low-pass, band-pass filters to split the signal 2212 into a high frequency portion corresponding to first portion 2214, and a low frequency portion corresponding to second portion 2216. The second portion 2216 is amplified at amplifier 2206 to produce an amplified signal 2218. Below is a more detailed description of amplifiying or enhancing the low frequency or bass portion of the signal (bass enhancement).

The controller 2200 may include a switch 2208 for controlling the nature of the signal 2220 being sent to the transducer 2000. In certain embodiments, the switch 2208 includes a 3-way switch. In such embodiments, in a first mode, the switch 2208 may be configured to transmit to the transducer 2000 the first portion 2214. In a second mode, the switch 2208 may be configured to transmit to the transducer 2000 the amplified second portion 2218. In a third configuration, the switch 2208 in connection with other processing circuitry 2210, e.g., a summing circuit, amplifier, transistor, operational amplifier, or like signal combiner, may be configured to transmit a combination of both portions 2214 and 2218. The switch 2208 may be mechanical, electromechanical, micromachined, MEMS-based, integrated circuit (IC) based, hardware and/or software based.

Any of the components 2204, 2206, or 2208 may include a microprocessor for controlling the operation of any of the components 2204, 2206, or 2208. In one embodiment, the microprocessor is included in a separate IC and controls some or all of the components in the controller 2202. The microprocessor may include or interface with a memory configured to store instructions of a software program, function, and/or application. A function or application may be configured to control one or more of the components 2204, 2206, 2208, or other components based on the instructions stored in the memory, e.g., a computer readable medium. For example, the application may dynamically control the switching of the switch 2208 based on a detected signal 2212, 2214, and/or 2216. The application may, for example, control the splitter 2206 or filter 2204 to set the frequency and/or bandwidth for filtering or splitting. The microprocessor may include a digital signal processor (DSP), running microcode or the like, to perform certain functions. Any of the various illustrative systems disclosed herein may include a microprocessor controller as described above. In some embodiments, any of the signals, at any stage of signal processing, may be converted and processed as digital signals, and then converted to an analog signal for driving the output audio and/or haptic signals.

The switch 2208 and processing circuitry 2210 arrangement are one example of how signals may be combined and/or separately provided to the speaker 2000 or a driver circuit. Other arrangements may be employed. For example, a set of switches may be used to block or pass any one of the signals to the speaker 2000. An amplifier may be used to combine the signals 2214 and 2218 while a switch is enabled or disabled to pass the combined signal to the speaker 2000 or a driver circuit or other component. Those of ordinary skill will understand that various other arrangements may be employed to effect the combining and/or selection of various signals.

In certain embodiments, the incoming electrical audio signal 2212 may be a stereo signal configured to be processed and transformed to sound by a plurality of transducers. FIG. 23 is a block diagram of two acousto-haptic transducers coupled to a controller for processing stereo sound and haptics, according to an illustrative embodiment of the invention. In particular, FIG. 23 shows a system 2300 including two acousto-haptic transducer 2000a and 2000b connected to a controller 2302. Incoming electrical signals 2212 are split into two portions similar to controller 2202 of FIG. 22. One portion of the signal 2212 corresponding to the haptic portion may be amplified and optionally recombined with the audio portion. Controller 2302 further includes processing circuitry 2350 for separately driving the left transducer 2000a and right transducer 2000b.

Acousto-Haptic Systems 2200 and 2300 described above may receive electrical signals containing audio information from a variety of media and devices. Example media include music, movies, television programs, video games, and virtual reality environments. Example devices that can provide data and be used in conjunction with a vibration device include portable music players, portable video players, portable video game consoles, televisions, computers, and home entertainment systems. Exemplary acousto-haptic systems may connect to exemplary devices via an audio jack coupled to a wire or may contain a wireless receiver for wirelessly receiving signals from a device equipped with a wireless transmitter.

Using an acousto-haptic device in conjunction with a media device can enhance the user's interaction with the media by creating tactile sensations that synchronize with the data being presented by the media device. For example, soundtracks that accompany movies typically have, in addition to music and dialogue, sounds that accompany the action in the movie, such as a door slamming or an explosion. The acousto-haptic device, by transforming these sounds into vibrations, allows the user to simultaneously feel this action in addition to seeing and hearing it, which can create a more immersive experience for the user. This immersive effect can be especially desirable when the visual data is poor, for example portable devices with small video screens or computer monitors with relatively low resolution. As another example, the user's perception of music may be enhanced by the vibration device, which can create a tactile sensation synchronized with the music by using the same data source as the audio speakers. This enhancement can be especially desirable for experiencing the low frequency component, also known as bass.

As noted above the acousto-haptic systems 2200 and 2300 can include processing circuitry capable of processing electrical signals for enhancing the content perceived by the user or allowing the user to modify the content. Exemplary functions of processing circuitry include selecting acoustic and/or haptic signal portions, pitch control, volume control, fade-in, amplitude-ceiling, auto shut-off, channel separation, phase-delay, and bass enhancement, whose implementations are well-known to one skilled in the art. Pitch control allows a user to increase or decrease the overall frequency of an electrical signal. Volume control allows a user to increase or decrease the overall amplitude of an electrical signal. Fade-in gradually increases the amplitude of the beginning of an electrical signal to lessen the initial impact of vibrations on a user. Amplitude-ceiling creates an upper bound on the magnitude of the amplitude of the electrical signal to prevent the user from experiencing excessively intense vibrations. Auto shut-off turns off the processing circuitry to conserve power without receiving input from the user and when an electrical signal has not been received for a preset amount of time. Channel separation separates a stereo or multichannel signal into its component channels. Phase-delay delays a signal sent to a second vibrator with respect to a signal sent to a first transducer to give the user the impression the sound originated from a location closer to the first transducer than the second transducer. Bass enhancement increases the amplitude of the bass component of an electrical audio signal relative to the rest of the signal.

Examples of multichannel signals that can be separated by processing circuitry include stereo sound, surround sound, and multichannel haptic data. Stereo sound typically uses two channels. Channel separation circuitry can separate a stereo sound two-channel electrical audio signal into a left channel signal and a right channel signal intended to be experienced by the user from, respectively, a left-hand side and a right-hand side. Multichannel electrical audio signals, such as those used in 5.1 and 6.1 surround sound, can similarly be separated, and typically contain rear channel signals intended to be experienced by the user from the rear. Channel separation circuitry can also separate multichannel haptic data, such as those used with video games or virtual reality environments, that similarly contain data intended to be experienced by the user from a specific direction.

Multiple implementations of bass enhancement are possible. In one implementation, an electrical signal is received at an input for transmitting to a transducer and/or audio speakers. A low frequency cross-over circuit can filter through only the bass component of the received electrical signal, whose overall amplitude is increased by an amplifier before reaching a transducer.

Another bass enhancement implementation increases the bass component without filtering out the rest of a signal. Processing circuitry can sample a received electrical signal to create a sampled signal, modulate the pitch of the sampled signal to create a modulated sampled signal, and mix the modulated sampled signal with the received electrical signal to create a signal for the transducer. The modulation of the pitch preferably lowers the pitch of the sampled signal to increase the bass component of the signal received by the transducer. The user may also control the degree of bass enhancement by lowering the overall frequency of a signal using pitch control.

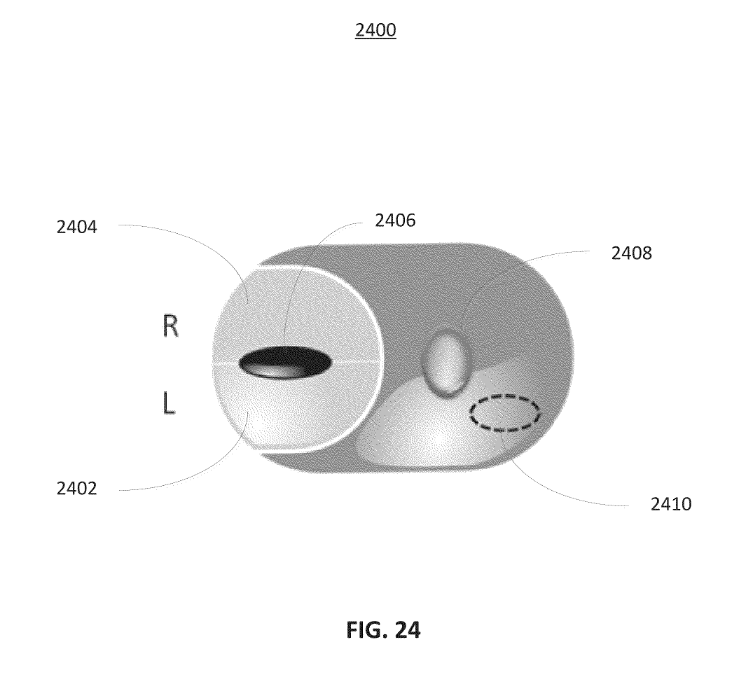

FIG. 24 depicts an exemplary mouse 2400 with vibrators, according to another illustrative embodiment of the invention. The mouse 2400 includes a left button 2402, a right button 2404, a scroll wheel 2406, a mode button 2408, and a vibrator 2410. In one example, buttons 2402 and 2404 control haptic output on the vibrator 2410. The right buttons may be pre-programmed with click sequences or patterns for activating haptic signal output. For example, haptic signal output may be desirable only when the corresponding audio information was caused by input from the user. This in effect, activates a “self” mode. For example, when user shoots a target in a game, he may only feel his own gun recoil, and when his or her shooting stops, no other haptic effect can be felt. On the other hand, deactivating the haptic feedback when either buttons are clicked may correspond to a “non-self” mode, which may in term be a good application for conditions where the environmental effects are more important to the user such as whether/where the enemy is shooting from. An additional “all” mode may allow the user to feel both “self” and “non-self” haptic effects. In certain embodiments, mode button 2408 functions as a toggle switch to toggle among different modes. In other embodiments, the modes may be switched through a particular mouse click pattern with pre-defined durations. The corresponding functions of each of the buttons may be pre-programmed with default values, or may be programmable by the user. Equivalents, similar self and non-self modes may be achieved with other types of input interfaces such as keyboards, where particular keyboard buttons such as the space bar is used for shooting.

In certain embodiments, one or more buttons on the input device may be used to perform one or more functions in connection with controlling the operation or level of vibration. For example, the middle scroll button 2406 on the mouse, typically located between the right button 2404 and the left button 2402, can be used as a vibration intensity controller. The middle scroll button 2406 may also be configured to be used as a “depth of field” selector, especially for the non-self mode, where closer effects such as nearby explosions etc. are more important than those at a larger distance. In certain embodiments, the input device may include one or more acousto-haptic speakers configured for generating acoustic and haptic effects using audio signals. For example, the vibrator 2410 may be an acousto-haptic speaker. In such input devices, one or more buttons or input switches may be configured to, directly or indirectly, activate, generate, control, modulate, reconfigure, and adjust the intensity of one or more haptic effects. In an acousto-haptic mouse, where audio information from the game activates/generates the haptic effects, the scroll wheel 2406 (when pressed) can change the input volume to the low-pass/acousto-haptic driver module. Alternatively, a separate scroll wheel can control the depth of field. Many other effects incorporating any suitable vibrators as described above in reference to FIGS. 1-23 can be activated and controlled as described here. In the case of an acoustic-haptic transducer, the mass elements of the acousto-haptic transducer may be rigidly connected to a diaphragm so that harmonics generated by the surface covered by the adhesion surface are minimized, and the mass is moved away from the surface so as to allow proper emission of the sound without blocking it. In certain embodiments, more than one vibrator may be position around the housing of the haptic mouse 2400. For example, two separate vibrators corresponding to different sound channels may be positioned on opposing left and right sides of the haptic mouse 2400. In another example, vibrators may be positioned below buttons 2402 and 2404, or as vibrating surfaces appropriately places on the buttons.

In certain embodiments, the apparatus as described herein is connectable with a portable electronic and/or consumer electronics device and provides haptic information and/or feedback to a user of the portable electronic device. The apparatus may also function as a partial housing for a portable electronic device. The apparatus may include an electrical and/or mechanical connection with a portable electronic device to enable to the exchange of electronic data between the apparatus and portable electronic device. The apparatus may include one or more transducers that provide at least one of audio and haptic output to a user of the portable electronic device. The haptic and/or audio information may be associated with media being displayed, played, and/or stored on the portable electronic device. The apparatus housing may include a hard case having a relatively low mass to enhance the propagation of haptic information (e.g., vibrations). A user may interface with the apparatus via one or both hands. In certain embodiments, the apparatus may clip on to a portable electronic device such that user may interface with the portable electronic device via one or both hands. The apparatus may be segregated into a plurality of physical regions where each region is associated with a vibration unit providing certain haptic information. User input received on the portable electronics device may be processed by the portable electronic device directly to determine if audio signal corresponding to the self or non-self modes should be transmitted to the haptic housing. User input may be received on the portable electronic device directly, or through a user input interface embedded in the haptic housing. User input may be analyzed by the portable electronics device or by processing circuitry included in the haptic housing to control haptic signal output.

The docking apparatus may be arranged in any number of dimensions so as to releasbly hold a portable electronic device. A portable electronic device may include a cellular telephone, portable computer, tablet computer, personal digital assistant (PDA), portable electronic game device, a consumer electronic device, and/or a hand-held electronic device.

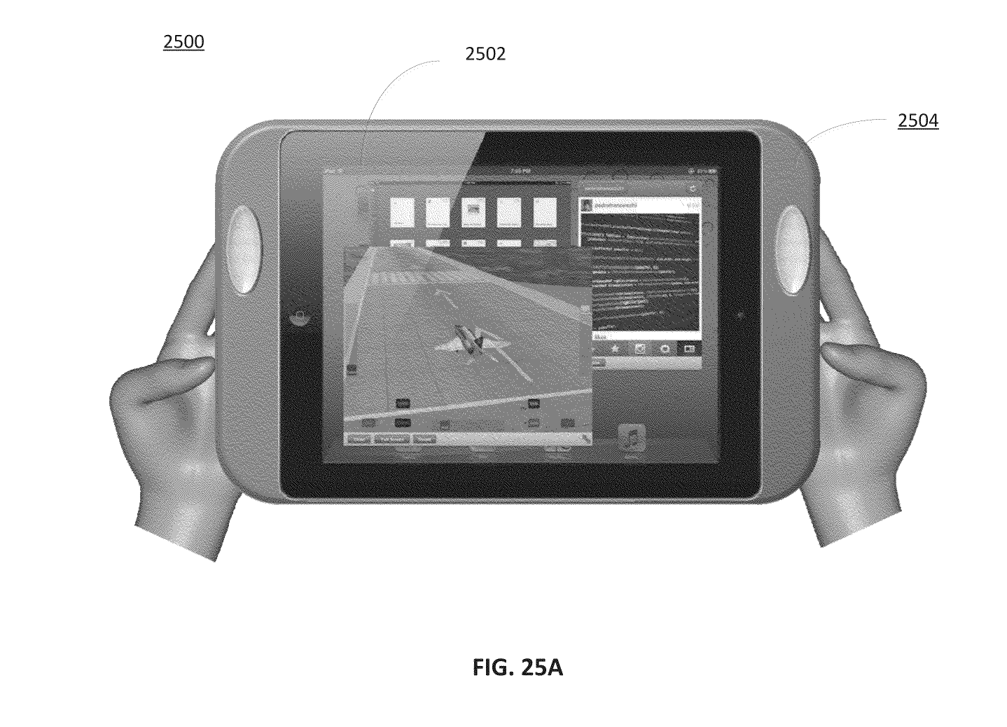

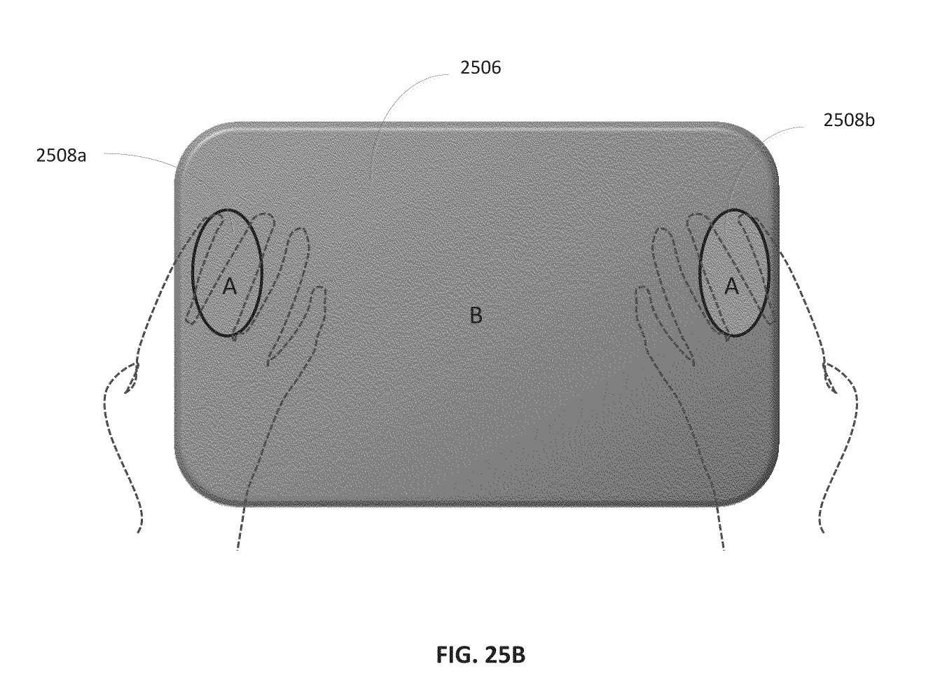

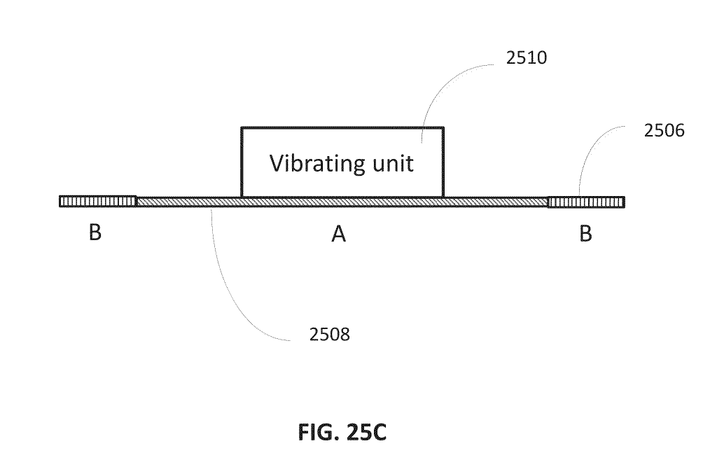

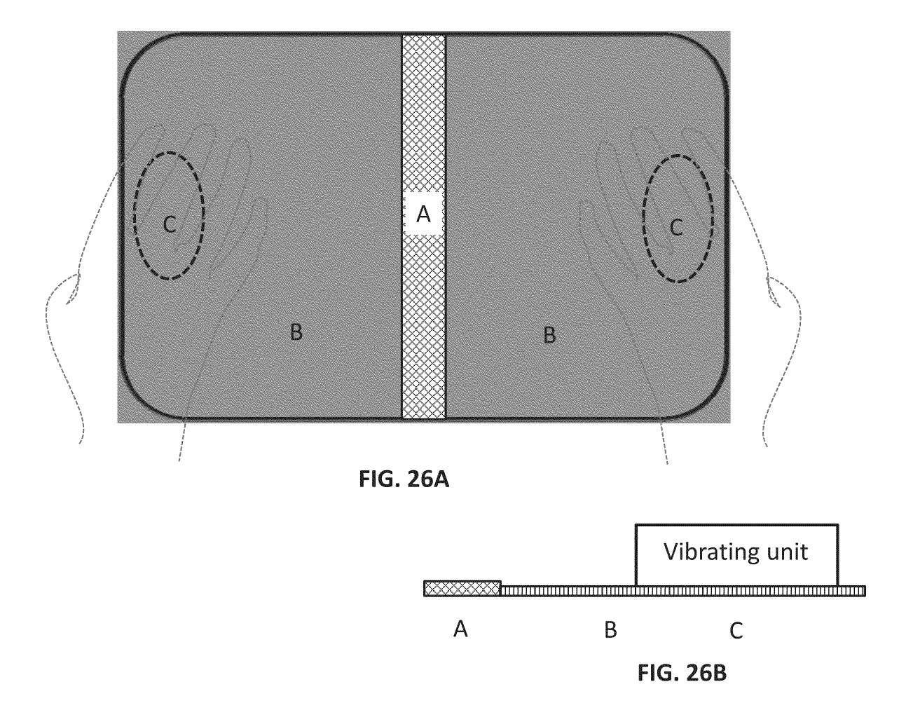

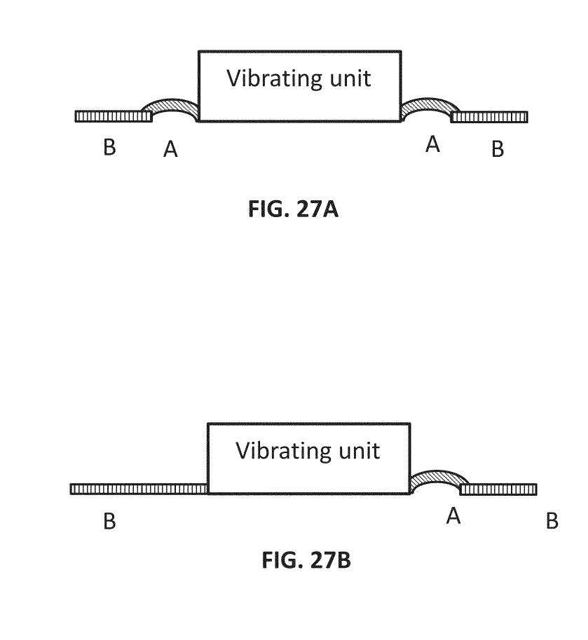

In some configurations, as shown in FIGS. 25A-25C, a vibrating unit 2510 or element is rigidly attached to an elastic membrane that easily transfers vibrations to its surface (A) 2508 but dampens vibration being transferred to adjacent non-elastic hard surface (B) 2506 that's connected to A e.g. by comolding. The user's fingers touching surface A 2508a and 2508b can feel the vibration, but the vibration is attenuated when touching surface B 2506. This allows isolation of different vibration effects being experienced on the elastic surfaces (A) 2508a and 2508b if two or more such vibrating surfaces are present. An example is shown in FIGS. 25A and 25B, where two (Right and Left) vibrating surfaces 2508a and 2508b are present and independent vibration of each area allow various possibilities such as directional information on gun shots in a mobile game, or sensation of motion by sequentially vibrating Right and Left vibrators with a variable lag that provides sensation of the Haptic effect moving from one to the other side. In certain configuration, as shown in FIGS. 26A-26B, the elastic membrane surface 2508 overlaying the vibrating unit 2510 may be adjacent to another similar or different elastic layer 2512 which in turn may be adjacent to a non-elastic hard surface 2514. In such a configuration, the docking apparatus may allow for a larger region on which the user's fingers may be the vibration. To allow for further haptic effects, the vibrating unit 2510 may itself be attached to one or more damping materials A on one or more sides of the vibrating unit 2510, as shown in FIGS. 27A and 27B.

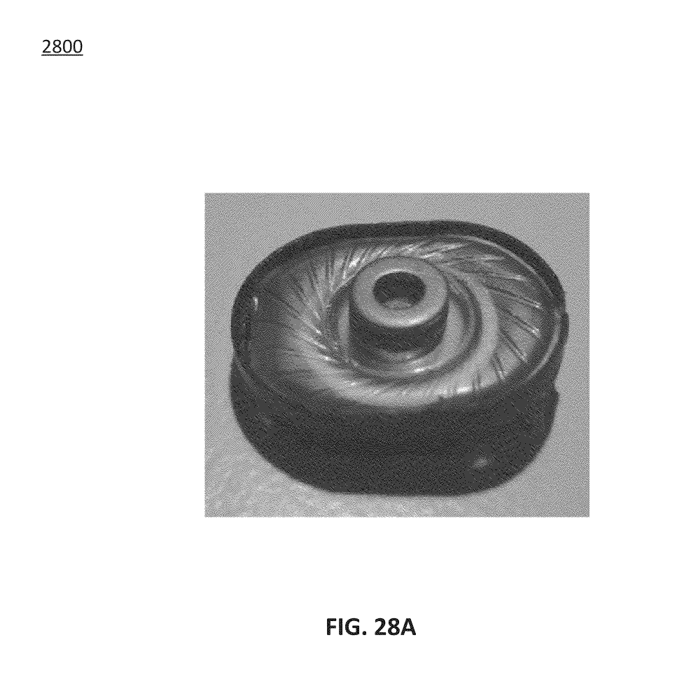

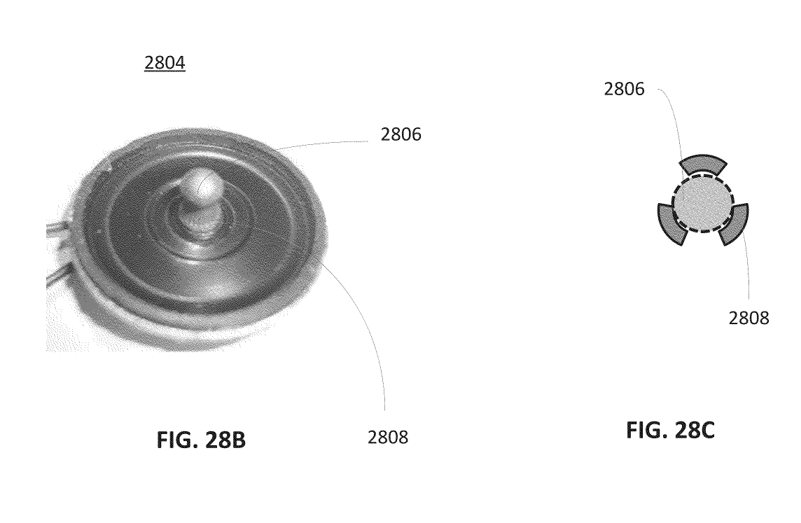

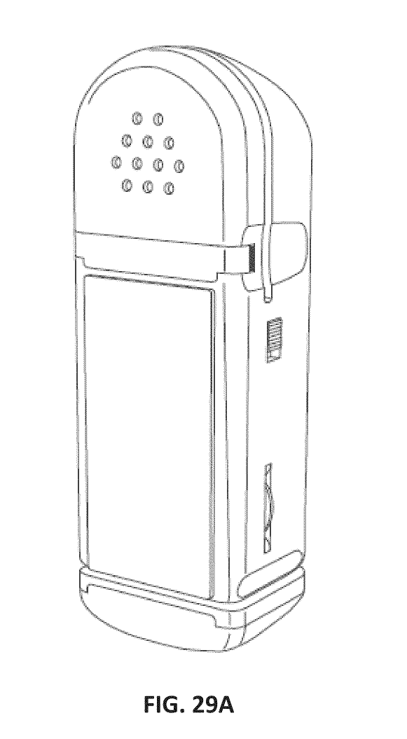

The application also discloses a vibrating unit that includes an acousto-haptic (ACH) speaker as described in U.S. Patent Publication No. 2010/0260371, the contents of which are incorporated by reference herein in their entirety, and described in detail above in reference to FIGS. 20A-23. The mass elements of the ACH speaker may be rigidly connected to a diaphragm so that harmonics generated by the surface covered by the adhesion surface are minimized, and the mass is moved away from the surface so as to allow proper emission of the sound without blocking it. In FIG. 28A, an annular mass element 2800 with partial base is shown. The sound from the region inside the annulus can be emitted without the mass element blocking it. FIGS. 28B and 28C depicts an ACH speaker 2804 is shown in which the surface area of the adhesion zone 2808 of the mass element 2806 is kept small. Not to be bound by theory, but the smaller the surface area of the adhesion zone of mass diaphragm the better the quality of the audio even if it is partial. FIG. 28C depicts a mass element mounted on a three-pronged base. Generally, the base may include any suitable number of prongs without departing from the scope of the disclosure. In certain embodiments, care is given to the fact that the speaker produces symmetric vibrational modes, and that the mass element base is similarly symmetric to avoid wear and tear and breaking of the adhesive layer, which would cause the mass element to dislodge and damage the speaker. In certain configurations, the vibrator unit is rigidly attached to a device and has a low mass and suitable flexibility to allow for better transfer of vibration. In certain configurations, the mass may be greater than or equal to 0.01 grams. In some configurations, the mass may be greater than or equal to 0.1 grams. The mass may include a non-magnetic metal and/or any suitable material.

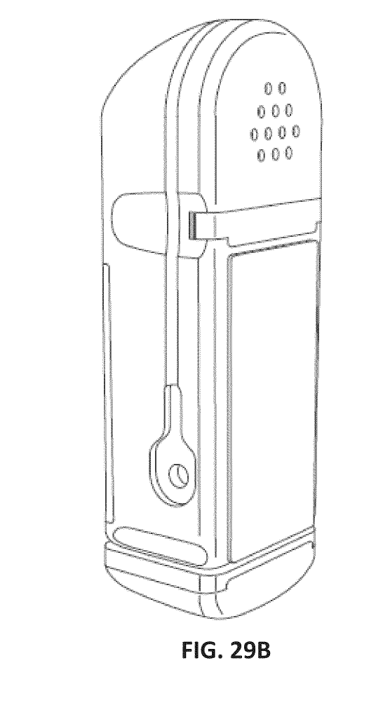

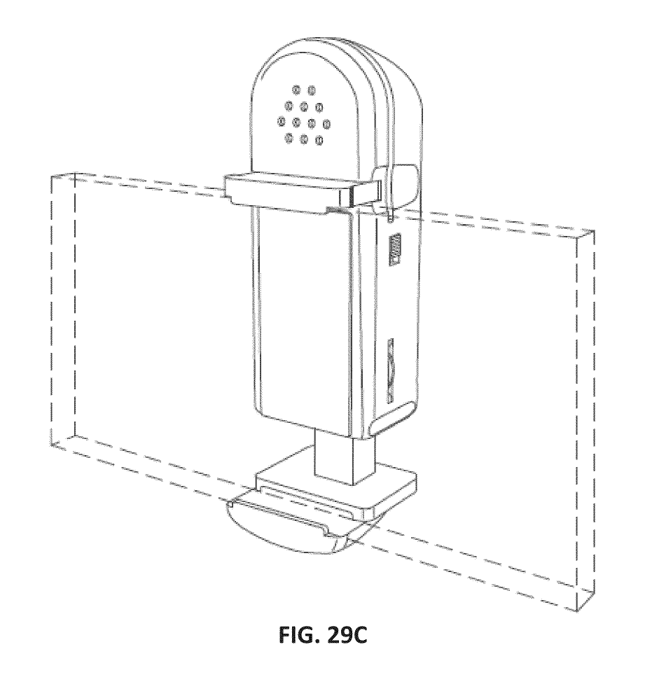

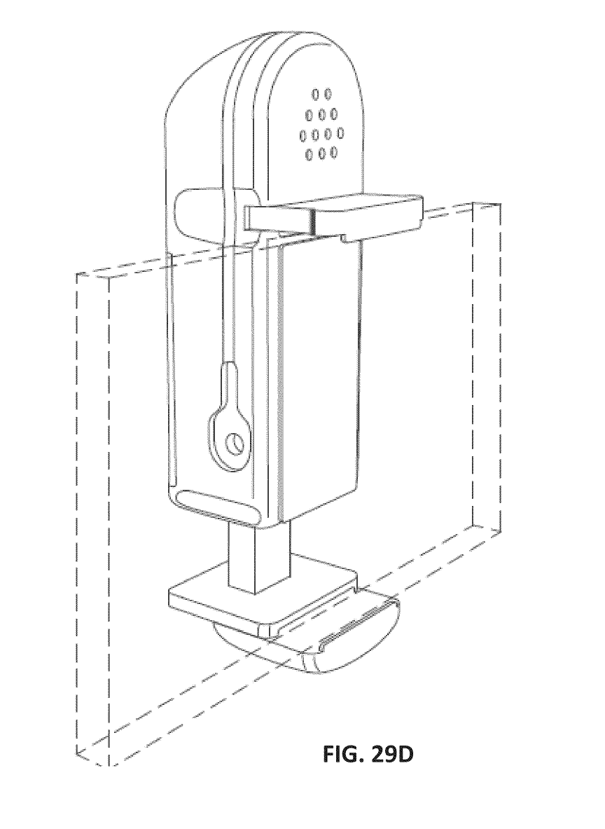

The application includes an apparatus connectable with a portable electronic and/or consumer electronics device such as a mobile phone or smartphone device that provides haptic information and/or feedback to a user of the portable electronic device. As depicted in FIGS. 29A-29D The apparatus 2900 may include an ACH speaker housed in a plastic housing and configured to clip on to a portable electronic device. In one implementation, the apparatus may have a closed state (shown in FIGS. 29A and 29B) and an open state (shown in FIGS. 29C and 29D). As shown in FIGS. 29A and 29B, the apparatus may be in a closed state to allow for convenient storage. In such a closed configuration, the outer surface of the housing may be generally smooth and compact. As shown in FIGS. 29C and 29D, the apparatus may be operable in an open state so that it may be coupled to a portable electronic device. In one implementation, in an open state, the apparatus may include two trays 2902 and 2904 that may be configured to grip the top and bottom of the portable electronic device. Each of these trays may be retractable such that in open state they may extend outwardly from the housing and in a closed state they may be retracted and secured within the housing. In certain implementations, the bottom tray 2904 may include a spring loaded extender that may be configured to exert force once the apparatus is in an open state. The spring loaded extender mechanism may allow the apparatus to couple with portable electronic devices having different widths. For example, the apparatus may couple with cellphones having widths ranging from 2 inches to 3.25 inches. The housing of the apparatus may be substantially rigid and formed from any suitable material, including, for example, high-gloss white plastic material. In certain embodiments, the apparatus may be about 3.4 inches in length, about 1.4 inches in width, about 0.8 inches in height and may weight about 0.1 lb.

During operation, a portable electronic device may be coupled with the ACH apparatus as shown in dashed lines in FIGS. 29C and 29D. Once coupled, the apparatus may be configured to generate at least one of sound and vibrations. The apparatus may be connected electrically with the portable electronic device and may be configured such that sounds generated by the portable electronic device are used by the apparatus to generate haptic signals. Such sound signals may be pre-processed by the portably device into “self” mode and “non-self” mode outputs. Alternatively, some user input information to the portable device may be transmitted to the ACH apparatus as shown in FIGS. 29A-29D and processed therein to control haptic output through the apparatus. In certain embodiments, when the apparatus is coupled to the portable electronic device, the speaker output in the portable device may be automatically turned down or turned off. In such an embodiment, users may hear sounds generated from the portable electronic device via headphone, while experiencing haptic signals or vibrations generated from the apparatus.

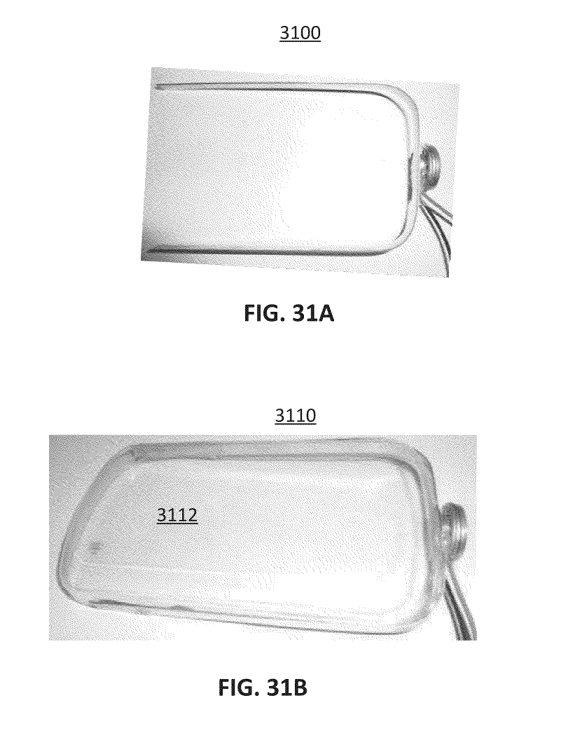

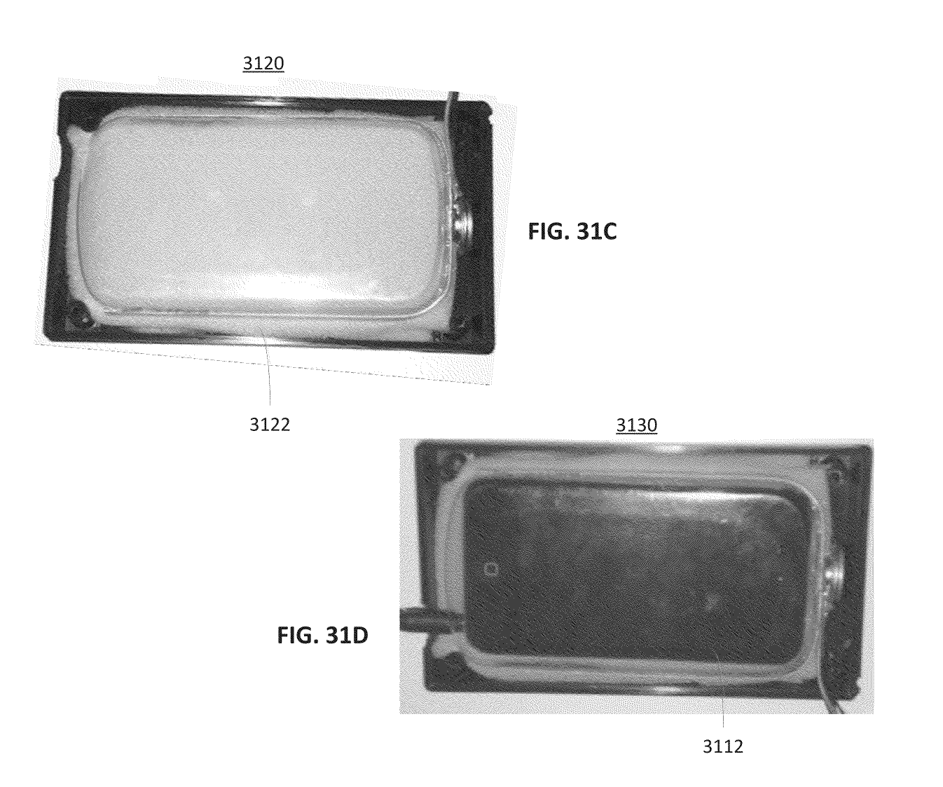

In certain embodiments, as depicted in FIGS. 31A-31D, the application includes an apparatus having a vibrating membrane with a waveguide that transfers haptic or vibrational feedback to a user that touches the membrane using, for example, their finger. In one aspect, the membrane may be transparent, allowing the membrane to be overlaid over a touch screen, keypad, and/or keyboard to provide haptic feedback to a user as the user types on the touch screen. In this way, a user can continue to view the touch screen or display of a media device while experiencing haptic sensations from the vibrating membrane. The vibrating membrane may include a dissipation-free 1D or 2D waveguide to affect the transfer of vibrational energy to the point of contact between a user and the membrane. The membrane may operate concurrently with a processor and sound source that provides sounds with the vibrations such as the sound that emulates a key stroke. The system may include a datastore and/or database that stores haptic vibration files and/or sound files for playback when a user touches the membrane at one or more locations. The system may further include a processor arranged to receive input from the vibrating membrane indicating contact with a user and, in response, retrieving a file from the datastore to send to a vibration source coupled to the vibrating membrane, whereby the vibrating source converts the electronic data of the file to an acoustic and/or haptic signal emitted from the vibrating membrane. The vibrating membrane may be integral with and/or attached to a docking apparatus. In one configuration, the vibrating membrane and docket apparatus form a housing or skin for a portable electronic device such as a mobile phone, tablet, or PDA.

Not to be bound by theory, but a point source of waves generally radiates its power radially, and thus points farther away from the source receive less power compared to those closer to the source. Generally waveguides are media with low dissipation that allow an efficient transfer of the waveform from one point to the next in order to avoid this weakness. This principle typically applies to both transverse as well as longitudinal waves.

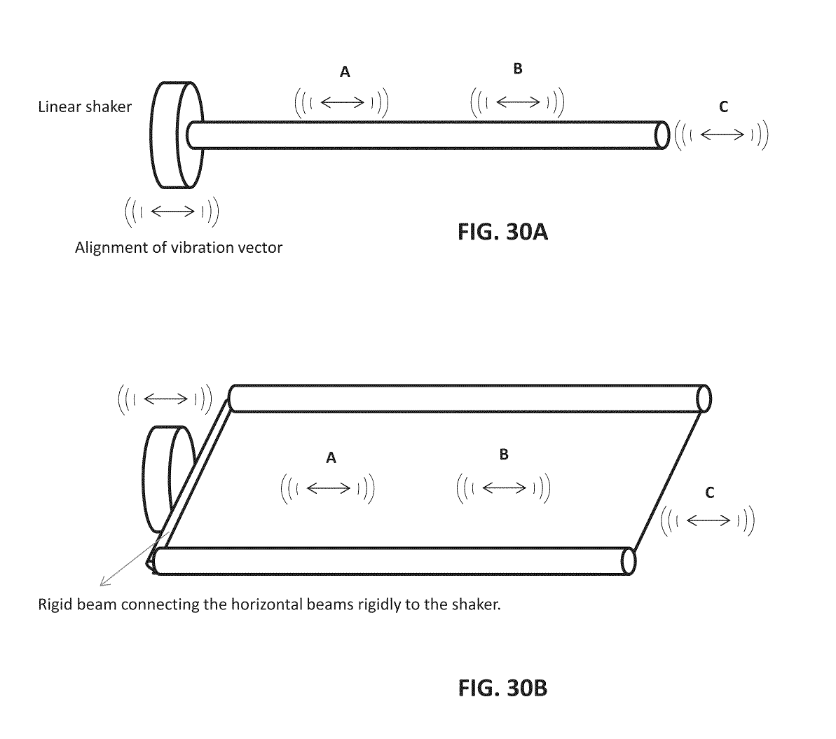

Haptic vibrations are also waveforms that, depending on the type of source, generate omnidirectional (offset mass motor) or unidirectional vibrations (linear motor shakers). As shown in FIGS. 30A and 30B, if a narrow rigid beam or a strip is rigidly attached to a source, the energy of the vibration is transferred from the source to the end of the beam and anywhere along the beam. In the case of linear motor shakers, the vibration is directional such that the force generated is parallel to the displacement vector of the vibrating mass. If the rigid beam is connected to the linearly vibrating element parallel to the displacement vector, then since the entire beam is coupled and is considered to be incompressible, the entire beam moves back and forth, thus at any point along the beam the same amount of vibrational energy is found, providing a dissipation-free waveguide for the haptic vibration. The energy transfer of vibrations perpendicular to the beams are also improved for both 1D and 2D waveguides when rigid beams or strips are used, so a rotating offset mass vibrator can also be used as the vibrating element. FIG. 31A depicts an apparatus 3100 having a vibrating device and rigid waveguide elements extending on either side of the vibrating device. The rigid elements may be positioned such that they extend along the sides of a portable electronic device, e.g., smartphone, placed in between.

In certain embodiments, as shown in FIG. 30B, the above principle is applied to a 2D thin surface, as well. If the edges of the surface are made as narrow rigid beams, then, the vibrations of the source can be couple to the beams such that the entire surface of the 2D membrane vibrates along the displacement vector of the mass on the linear shaker. The plane of vibration would be the same as the surface of the membrane, and be of the longitudinal form. FIG. 31B depicts such an apparatus 3110 having a vibrating device, rigid waveguide elements extending on either side of the vibrating device, and a membrane 3112 extending therebetween. The interesting effect of such waveguides apart from dissipation-free distribution of vibration (i.e. every point on the surface provide the same intensity of vibration) is that if pressed by a finger, the curvature generated on the surface of the membrane by the tip of the finger changes the geometry of the vibration and thus produces some transverse as well as longitudinal vibrations.

In certain embodiments, the vibration may be isolated to the rigidly connected members to the shaker, by either suspending the vibrating parts, or putting compressible membranes such as foam or thin rubber between the vibrating and non-vibrating parts. As shown in FIG. 31C, the vibrating portions of the apparatus 3120 may be placed in foam 3122. Moreover, as shown in FIG. 31D, the apparatus 3130 may be positioned such that a portable electronic device is placed under the membrane 3112.

Applicant considers all operable combinations of the embodiments disclosed herein to be patentable subject matter. Those skilled in the art will know or be able to ascertain using no more than routine experimentation, many equivalents to the embodiments and practices described herein. Accordingly, it will be understood that the disclosure is not to be limited to the embodiments disclosed herein.

1. An apparatus, comprising:
a housing;
processing circuitry, disposed within the housing, for receiving and transmitting user input; and
a transducer, disposed within the housing, having a speaker including a diaphragm and a mass element attached to a portion of the diaphragm, wherein the transducer is capable of transforming audio information in an electrical signal into both acoustic and haptic signals.

2. The apparatus of claim 1, further comprising a user input interface disposed on the housing and connected to the processing circuitry for receiving user input, and wherein the haptic signal is generated, activated, controlled, modulated, reconfigured, or adjusted, directly or indirectly, in response to a user input received at the user input interface.

3. The apparatus of claim 2, wherein the user input interface includes at least one of a button, a scroll wheel, a scroll button, a switch, a touch-sensitive region, a touch screen, a light pen, a joystick, or a motion sensor.

4. The apparatus of claim 2, wherein the processing circuitry is configured to modulate, reconfigure, or adjust the electrical signal.

5. The apparatus of claim 2, wherein the processing circuitry is configured to generate, activate, control, modulate, reconfigure, or adjust the haptic signal.

6. The apparatus of claim 2, wherein the electrical signal is processed by the processing circuitry according to the user input received at the use input interface.

7. The apparatus of claim 2, wherein the user input interface is pre-programmed.

8. The apparatus of claim 2, wherein the user input interface is programmable.

9. The apparatus of claim 3, wherein the touch-sensitive region is capacitive sensing.

10. A method of generating haptic signals from audio information in an electrical signal, comprising
providing a user input device having a user input interface and a transducer having a mass element disposed on a diaphragm of a speaker,
receiving a user input at the user input interface;
receiving, at the transducer an electrical signal containing audio information; and
generating, at the transducer, acoustic and haptic signals based on the audio information in the electrical signal and in response to the user input.

11. The method of claim 10, further comprising generating the electrical signal in response to the user input.

12. The method of claim 11, wherein the audio information in the electrical signal is generated according to the user input.

13. The method of claim 11, wherein the electrical signal is generated only in response to the user input.

14. The method of claim 10, further comprising processing the electrical signal based on the user input, wherein the processing includes at least one of modulating, reconfiguring or adjusting the electrical signal.

15. The method of claim 10, wherein the user input interface includes at least one of a button, a scroll wheel, a scroll button, a switch, a touch-sensitive region, a touch screen, a light pen, a joystick, or a motion sensor.

16. A method of generating haptic signals from audio information in an electrical signal, comprising
providing a user input device having a user input interface, processing circuitry, and a vibrator,
receiving a user input at the user input interface;
receiving, at the processing circuitry an electrical signal containing audio information; and
generating, at the vibrator, haptic signals based on the audio information in the electrical signal and in response to the user input.

17. The method of claim 16, further comprising generating the electrical signal in response to the user input.

18. The method of claim 17, wherein the audio information in the electrical signal is generated according to the user input.

19. The method of claim 17, wherein the electrical signal is generated only in response to the user input.

20. The method of claim 16, further comprising processing the electrical signal based on the user input, wherein the processing includes at least one of modulating, reconfiguring or adjusting the electrical signal.
